(19) United States
(12) Patent Application Publication
(10) Pub. No.: US 2026/0337802 A1
(43) Pub. Date: Oct. 29, 2026

(54) PRETREATMENT METHOD FOR PREPARING ULTRAPURE HYDROGEN AND ULTRAPURE OXYGEN

(71) Applicant: PHIL & FLOR COMPANY LIMITED, Hong Kong (CN)

(72) Inventor: Chiu Yiu FUNG, Hong Kong (CN)

(21) Appl. No.: 19/107,782

(22) PCT Filed: Aug. 24, 2023
(86) PCT No.: PCT/IB2023/058396

§ 371 Date: Feb. 28, 2025

(30) Foreign Application Priority Data
Aug. 30, 2022 (CN) 202211049410.6
May 31, 2023 (CN) 202310633630.1

(51) Int. Cl. C25B 15/08; C25B 1/04; C25B 15/02

(52) U.S. Cl. CPC C25B 15/085; C25B 1/04; C25B 15/02

(57) ABSTRACT

The present invention provides a pretreatment method for preparing ultra-pure hydrogen and ultra-pure oxygen, comprising steps: before desalinated water entering an electrolytic cell, desalinated water being fed into the top of a storage tank through a desalinated water pipe; at the same time, using hydrogen gas or oxygen gas as a stripping gas, being fed into the top of a storage tank through a gas supply pipe for performing atomization and stripping pretreatment of desalinated water; before desalinated water entering an electrolytic cell, hydrogen gas or oxygen gas being fed into the bottom of a storage tank through a gas supply pipe, using hydrogen gas or oxygen gas to perform bubbling, redundant stripping, and to provide a slightly-positive pressure blanketing on pre-treated desalinated water; performing water-mist separation on the exhaust of a storage tank, of which the water in supersaturated water vapor being captured and recycled to a storage tank. In the pretreatment method provided by the present invention, the desalinated water after stripping subsequently enters the electrolytic cell to be decomposed into hydrogen and oxygen, and then through catalytic deoxygenation/dehydrogenation, condensation drainage and molecular sieve adsorption drying, ultrapure hydrogen meeting the requirements of GB/T 3634.2-2011 and ultra pure oxygen meeting the requirements of GB/T 14599-2008 are produced, and at the same time, the production, equipment and maintenance costs are greatly reduced.

### TECHNICAL FIELD

The present invention belongs to the technical field of water electrolysis in industrial hydrogen production, and in particular to a pretreatment method for preparing ultra-pure hydrogen and ultra-pure oxygen.

### BACKGROUND ART

The process flow of industrial water electrolysis plant currently used to produce hydrogen gas (the basic process flow is shown in [FIG. 1]), includes but is not limited to the current mainstream water electrolysis technology such as alkaline water electrolysis (ALK), and emerging water electrolysis technologies such as proton exchange membrane water electrolysis (PEM), anion exchange membrane water electrolysis (AEM) and solid oxide water electrolysis (SOEC). Among them, PEM has been used in many new projects, European patent EP3649276B1 also discloses this water electrolysis technology to produce hydrogen gas. The process flow of industrial water electrolysis plant generally sends desalinated water (softened water) from the storage tank (101) into the hydrogen-liquid separator (301), and then feeds it into the electrolytic cell (201), under the electrolytic action of direct current, the water is decomposed into “crude” hydrogen gas and “crude” oxygen gas. Crude hydrogen and crude oxygen are cooled and sent to their respective gas-liquid separators (301 and 311) for performing gas-liquid separation, and then demisting and dewatering in their respective cooling/droplet catching/gas-liquid separation equipment (401 and 411). Crude oxygen is generally regarded as a by-product and is usually vented. After dewatering, crude hydrogen enters the deoxygenation unit (501). Under the action of the catalyst, the small amount of oxygen in the crude hydrogen reacts with hydrogen gas to generate water. Most of the water in the hydrogen is discharged after condensation. The remaining carbon dioxide and trace water are removed when passing through the molecular sieve adsorption drying device (601). The product hydrogen produced meets the technical requirements of GB/T 3634.2-2011 for pure hydrogen, but is inferior to the requirements of GB/T 3634.2-2011 for high pure hydrogen and ultrapure hydrogen. [Note: “ultra-pure hydrogen”, “high-purity hydrogen” and “pure hydrogen” mentioned in this specification refer to hydrogen gas that complies with the ultrapure hydrogen, high pure hydrogen and pure hydrogen specified in the National Standards of the People's Republic of China GB/T 3634.2-2011. (See Table 4 below)]

The main reason is that various air components (oxygen, argon, nitrogen, carbon monoxide, carbon dioxide and methane) dissolved in desalinated water will be released together during the water decomposition process in the electrolytic cell and become impurities in the product hydrogen. As mentioned in the previous paragraph, oxygen, carbon dioxide and water are effectively removed in post-purification process in the deoxygenation unit (501) and the molecular sieve adsorption drying device (601). However, as for carbon monoxide and methane, due to their extremely low solubility, their respective impurity contents released into the product hydrogen are less than 0.001 ppbV and 0.05 ppbV, which are less than the technical requirements for carbon monoxide and methane impurity contents in ultra-pure hydrogen. The remaining argon and nitrogen cannot be removed by the current common water electrolysis plant due to their inert characteristics to chemical reactions. According to Henry's Law, the composition of released argon and nitrogen in the product hydrogen can be as high as 0.24 ppmV and 9.1 ppmV respectively, which makes the product hydrogen inferior to the technical requirements of high-purity hydrogen and ultra-pure hydrogen.

The impurities of argon and nitrogen in hydrogen gas has little impact on most production industries using hydrogen gas due to their inert characteristics to chemical reactions, so there has never been any special requirement for argon and nitrogen in hydrogen gas. However, due to the development of many high-tech industries in recent years, the requirements for quality and quantity in the application of hydrogen gas have been increasingly demanding, especially for applications involving semiconductor production, such as EUV lithography and silicon thin film deposition, and epitaxy have begun to require argon in hydrogen should not exceed 70 ppbV since 2018. Argon and nitrogen, because of their inert characteristics to chemical reactions, it is indeed an extremely difficult task to remove them from hydrogen gas. At present, only palladium membrane diffusion or low-temperature adsorption post-treatment methods are generally used to remove them.

The unique function of the palladium membrane diffusion unit is to further upgrade the hydrogen gas that has reached the pure hydrogen specification to high-purity hydrogen or ultra-pure hydrogen. When pure hydrogen together with the impurities mixed in it (including oxygen, argon, nitrogen, and carbon dioxide) enter the palladium alloy membrane tube bundle, the hydrogen molecules will be adsorbed, dissociated, and dissolved into hydrogen atoms on the surface of the palladium membrane, diffuse from one side of the palladium membrane to the other side, and the released hydrogen atoms will re-combine into hydrogen molecules and desorb. Except for hydrogen, other gases cannot pass through the palladium membrane, thereby purifying pure hydrogen to ultra-pure hydrogen. However, the palladium membrane diffusion method has quite some disadvantages, including expensive equipment cost, high energy consumption, service life and hydrogen embrittlement, which are elaborated as follows:
Disadvantage 1. Palladium itself is quite a rare and precious metal element;
Disadvantage 2. To maintain a high hydrogen permeability, the working temperature of the palladium membrane diffusion generally needs to be increased to 300-500 °C;
Disadvantage 3. Long-term high temperature will shorten the lifetime of the palladium membrane;
Disadvantage 4. Instability of working temperature (such as power supply fluctuations) will cause hydrogen embrittlement problems.

This results in extremely high capital, production and maintenance costs on applying this purification method.

Low temperature adsorption is also to further upgrade the hydrogen gas that has reached the pure hydrogen specification to high-purity hydrogen or ultra-pure hydrogen. At present, a dual cylinder tank arrangement is generally used, with one in adsorption while the other in regeneration operating in turn. Most of these cylinder tanks adopt a coaxial three-layer construction. The central cylinder tank is filled with molecular sieves, the inner interlayer is soaked in liquid nitrogen, and the outer interlayer is a vacuum insulation layer. During adsorption, liquid nitrogen provides a low temperature environment of −196 °C to further enhance the adsorption efficiency of the molecular sieve. During regeneration, a 250 °C back-purging prompts the molecular sieve to desorb the impurity more thoroughly. Likewise, the low temperature adsorption method also has considerable disadvantages, including complicated equipment manufacturing technique, the need to add additional liquid nitrogen supply and auxiliary facilities, consuming nitrogen, consuming power and difficult to maintenance, as explained below:
Disadvantage 5. The manufacturing technical requirements of cylindrical tank having coaxial three-layer construction (or liquid nitrogen heat exchanger provided in a vacuum interlayer cylindrical tank) are high;
Disadvantage 6. In addition to the low-temperature adsorption unit, a liquid nitrogen supply auxiliary system is also required, including a liquid nitrogen tanker parking and unloading area and unloading facilities, a liquid nitrogen vacuum insulation storage tank, a vacuum infusion pipe and a heater for regeneration;
Disadvantage 7. Extra production costs on liquid nitrogen and electricity consumption;
Disadvantage 8. Repeatedly switching between-196 °C and 250 °C can easily cause stress and fatigue damage at welding areas. Even a hair-like fine crack can lead to vacuum breaking and product contamination. Locating and repairing cracks on a three-layer construction cylinder tank is an extremely difficult, time-consuming and costly task.

These disadvantages result in extremely high capital, production and maintenance costs for applying this purification method.

In addition to the two post-treatment purification methods of palladium membrane diffusion and low-temperature adsorption explained above, patent documents CN106283101 and CN101407920 also disclose methods for preparing ultra-pure hydrogen and high-purity hydrogen respectively by electrolyzing water. CN106283101 heats softened water to 95-100 °C to remove dissolved gas in the water and introduces high-purity oxygen to maintain pressure. CN101407920 uses oxygen gas to perform counterflow bubbling back-purging to the raw water. These two post-treatment purification methods also have their own disadvantages, which are:
Disadvantage 9. requiring additional heating energy consumption;
Disadvantage 10. Oxygen bubbling increases the amount of dissolved oxygen in the raw water by 3.6 times, seriously increasing the load on the subsequent deoxygenation unit, and reducing its performance and service lifetime.

Furthermore, the pure oxygen by-product of the water electrolysis process cannot compete with the oxygen products of other processes (such as air separation) due to its amortized production cost, so the pure oxygen produced by electrolysis is normally vented. How to not only improve the quality of the product hydrogen to ultra-pure hydrogen in water electrolysis process, but also economically recover the pure oxygen by-product and improve its quality to meet the technical requirements of GB/T 14599-2008 for ultrapure oxygen, and therefore greatly improving the value and application level of water electrolysis oxygen product, has also become a problem to be solved in the industry. In the semiconductor industry, ultra-pure oxygen is also one of the indispensable production materials, mainly used to grow silicon oxide layers of multi-element, remove any extra material scraps that are created during etching, and to make etching patterns stable.

### SUMMARY OF THE INVENTION

### Technical Problem

In view of the shortcomings of the above four methods for improving the purity of hydrogen gas, namely, high equipment cost, high energy consumption, relatively short service life, potential hydrogen embrittlement, complicated equipment manufacturing technique, difficult maintenance, additional liquid nitrogen facilities and liquid nitrogen consumption, and additional load on the deoxygenation unit. The present invention provides a pretreatment method with low equipment cost, strong and simple construction, no additional energy consumption and simple maintenance: using a small amount of self-produced hydrogen gas (or self-produced oxygen) from a water electrolysis process to atomize and strip the desalinated feed water, not only improves the quality specifications of product hydrogen to meet the technical requirements of ultrapure hydrogen in GB/T 3634.2-2011, but also recovers the pure oxygen by-product that is normally vented and upgrades it to ultra-pure oxygen. In addition, by controlling the flow rate of the stripping gas, the air impurity component dissolved in the desalinated water can be further reduced to meet the specially customized requirements of product hydrogen and/or product oxygen.

It should be noted that the “ultra-pure oxygen”, “high-purity oxygen” and “pure oxygen” mentioned in this specification all refer to oxygen gases that comply with the ultra pure oxygen, high purity oxygen and pure oxygen specified in the Chinese national standard GB/T 14599-2008. (See Table 5 below)

### Solution to the Problem

Since the hydrogen gas and oxygen gas produced by the current general water electrolysis plant, the impurities (mainly considering the target impurities stipulated by National Standards of the People's Republic of China such as hydrogen, oxygen, argon, nitrogen, carbon monoxide, carbon dioxide and methane) in them all come from various air components dissolved in the desalinated water. Therefore, the present invention adopts pretreating the desalinated water to solve the problem at the origin: before the desalinated water enters the electrolytic cell, the present invention preferably uses a small amount of hydrogen gas self-produced by the water electrolysis process (depending on the actual supply and demand, self-produced oxygen, externally-supplied hydrogen or externally-supplied oxygen can also be used) to perform atomization and stripping of desalinated water at the top of the desalinated water storage tank through a mixing nozzle, and bubbling of desalinated water through an aeration pipe arranged at the bottom of the storage tank, so as to provide it with a redundant stripping and slightly-positive pressure blanketing environment. The target impurities such as argon, nitrogen, carbon monoxide, carbon dioxide and methane originally dissolved in the desalinated water are thoroughly stripped and vented. When hydrogen gas is used for stripping and blanketing, the impurity oxygen in the desalinated water will also be thoroughly stripped and vented at the same time; when oxygen gas is used for stripping and blanketing, the impurity hydrogen in the desalinated water will also be thoroughly stripped and vented at the same time.

Subsequently, it is decomposed into “crude” hydrogen gas and “crude” oxygen gas in the electrolytic cell, gas-liquid separation is performed in their respective gas-liquid separators, and demisting and dewatering in the respective cooling/droplet catching/gas-liquid separating apparatus. The crude hydrogen and crude oxygen produced after dewatering contain impurities such as argon, nitrogen, carbon monoxide, carbon dioxide and methane, which meet the technical requirements of ultra-pure hydrogen and ultra-pure oxygen respectively (see Tables 11 to 18, row 18 is the crude hydrogen impurity component, row 30 is the crude oxygen impurity component). Subsequently, crude hydrogen and crude oxygen enter their respective catalytic deoxygenation unit and catalytic dehydrogenation units, and the impurity oxygen in hydrogen and the impurity hydrogen in oxygen are converted into water, and then subject to condensation draining and molecular sieve adsorption drying, respectively, the produced product hydrogen and product oxygen fully meet the technical requirements of GB/T 3634.2-2011 for ultrapure hydrogen and GB/T14599-2008 for ultra pure oxygen respectively.

In order to solve the above-mentioned technical problems, the technical solution adopted by the present invention is described as follows:

The present invention provides a pretreatment method for preparing ultra-pure hydrogen and ultra-pure oxygen, comprising the following steps:
a. before desalinated water entering an electrolytic cell, desalinated water being fed into the top of a storage tank through a desalinated water pipe; at the same time, using hydrogen gas or oxygen gas as a stripping gas, being fed into the top of a storage tank through a gas supply pipe for performing atomization and stripping pretreatment of desalinated water;
b. before desalinated water entering an electrolytic cell, hydrogen gas or oxygen gas being fed into the bottom of a storage tank through a gas supply pipe, using hydrogen gas or oxygen gas to perform bubbling, redundant stripping, and to provide a slightly-positive pressure blanketing on pre-treated desalinated water;
c. performing water-mist separation on the exhaust of a storage tank, of which the water in supersaturated water vapor being captured and recycled to a storage tank;
d. desalinated water obtained after pretreatment being used to produce product hydrogen and product oxygen through the subsequent water electrolysis process flow, and being stored in buffer tank.

In said pretreatment method, in step a, arranging a mixing nozzle on the top of said storage tank, its internal structure having individual independent passages respectively connecting to said gas supply pipe and said desalinated water pipe, two fluids of the fed hydrogen gas or oxygen gas and desalinated water being mixed and collided only at the outlet of said mixing nozzle.

In said pretreatment method, droplet diameter of said desalinated water in step a after atomization through said mixing nozzle being not less than 100 μm.

In said pretreatment method, in step b, arranging an aeration pipe at the bottom of said storage tank, volume flow rate of bubbling hydrogen gas or oxygen gas not less than volume flow rate of desalinated water.

In said pretreatment method, arranging an on-off valve, a pressure regulating valve, a pressure gauge, a flow regulating valve and a flow rate indicator in sequence on said gas supply pipe.

In said pretreatment method, in step a, installing a liquid level on-off valve on said gas supply pipe, between said on-off valve and said pressure regulating valve, on-off setting to close when the liquid level of a storage tank ≥95%.

In said pretreatment method, arranging an exhaust pipe on the top of said storage tank, arranging a droplet catcher on said exhaust pipe.

In said pretreatment method, also including a step of maintaining one slightly-positive pressure blanketing in a storage tank, arranging a check valve on the pipe of said droplet catcher outlet, opening pressure of said check valve not less than 250 N/m².

In said pretreatment method, also including the following steps:
e. feeding said product hydrogen or product oxygen in step d through said gas supply pipe for performing atomization and stripping pretreatment in step a, and/or for performing bubbling, redundant stripping and providing slightly-positive pressure blanketing in step b.

In said pretreatment method, further providing a four-way valve between said gas supply pipe and a buffer tank for selecting product gas or externally-supplied gas as stripping gas.

In said pretreatment method, said desalinated water being alkaline desalinated water, when producing said product hydrogen, in order to meet the target impurity concentration requirement of said product hydrogen, the vapor-liquid ratio of said stripping gas to desalinated water greater than or equal to the following value:

V/L=(x₀−y)/(K_{H}^{px}×y/P₁−y₀)
wherein, V is stripping gas flow rate, L is desalinated water flow rate, x₀ is impurity concentration in desalinated water, y is target impurity concentration requirement in product gas, K_{H}^{px} is Henry's Law constant, P₁ is absolute pressure, y₀ is impurity concentration in stripping gas.

In said pretreatment method, said desalinated water being alkaline desalinated water, when producing said product oxygen, in order to meet the target impurity concentration requirement of said product oxygen, the vapor-liquid ratio of said stripping gas to desalinated water greater than or equal to the following value:

V/L=(x₀−1.5y)/(K_{H}^{px}×1.5y/P₁−y₀)
wherein, V is stripping gas flow rate, L is desalinated water flow rate, x₀ is impurity concentration in desalinated water, y is target impurity concentration requirement in product gas, K_{H}^{px} is Henry's Law constant, P₁ is absolute pressure, y₀ is impurity concentration in stripping gas.

In said pretreatment method, said desalinated water being acidic or neutral desalinated water, when producing said product hydrogen, in order to meet the target impurity concentration requirement of said product hydrogen, the vapor-liquid ratio of said stripping gas to desalinated water greater than or equal to the following value:

V/L=(x₀−1.5y)/(K_{H}^{px}×1.5y/P₁−y₀)
wherein, V is stripping gas flow rate, L is desalinated water flow rate, x₀ is impurity concentration in desalinated water, y is target impurity concentration requirement in product gas, K_{H}^{px} is Henry's Law constant, P₁ is absolute pressure, y₀ is impurity concentration in stripping gas.

In said pretreatment method, said desalinated water being acidic or neutral desalinated water, when producing said product oxygen, in order to meet the target impurity concentration requirement of said product oxygen, the vapor-liquid ratio of said stripping gas to desalinated water greater than or equal to the following value:

V/L=(x₀−0.5y)/(K_{H}^{px}×0.5y/P₁−y₀)
wherein, V is stripping gas flow rate, L is desalinated water flow rate, x₀ is impurity concentration in desalinated water, y is target impurity concentration requirement in product gas, K_{H}^{px} is Henry's Law constant, P₁ is absolute pressure, y₀ is impurity concentration in stripping gas.

In said pretreatment method, when producing said product hydrogen and/or product oxygen, in order to meet all target impurity concentration requirements thereof, vapor-liquid ratio of said stripping gas to desalinated water greater than or equal to the maximum value among the vapor-liquid ratios of all target impurities in said product gas.

The present invention is to perform a minor modification on the current industrial water electrolysis process (see [FIG. 1]) commonly used to produce hydrogen gas, including existing plants already in use and process designs under planning, so that not only can its product hydrogen be economically upgraded from pure hydrogen to ultra-pure hydrogen, but also the crude oxygen by-product that is normally vented can be recovered at a very low marginal cost and upgraded it to high-value ultra-pure oxygen.

There are 10 main process modifications (see FIGS. 1 to 3):
Item 1. Add a flange connection (for convenient maintenance) on the top of the desalinated water storage tank, for adding a nozzle facility;
Item 2. Install a mixing nozzle on the above-mentioned connection;
Item 3. Add a flange connection near the bottom of the desalinated water storage tank, for adding an aeration pipe;
Item 4. Install an aeration pipe at the above-mentioned connection;
Item 5. The desalinated water pipe originally connected to the desalinated water storage tank inlet is changed to connect to the water inlet port of the mixing nozzle, and a flow rate regulating valve and a flow rate indicator are additionally installed;
Item 6. Adding catalytic dehydrogenation/condensation/gas-liquid separation unit, molecular sieve drying adsorption unit and product oxygen buffer tank for recycling and purifying the oxygen gas by-product that is supposed to be vented normally;
Item 7. Add an external connector to introduce: externally-supplied nitrogen for start-up and purging before hydrogen-oxygen exchange, or externally-supplied hydrogen as a substitute stripping gas option, or externally-supplied oxygen as a substitute stripping gas option;
Item 8. Add one pipe to each of the product hydrogen buffer tank, the product oxygen buffer tank and the externally-supplied gas external connector to the selector four-way valve (the four-way valve must be provided with a mechanical interlock to prevent the risk of ignition explosion and cross contamination caused by having hydrogen and oxygen come into connection), and the selected gas is fed, from the four-way valve through a tee fitting, one way supplying to the gas inlet port of the mixing nozzle and the other way supplying to the gas inlet port of the aeration pipe, before entering the mixing nozzle and the aeration pipe, arrange a flow rate regulating valve, a pressure regulating valve, a pressure gauge and a flow rate indicator on each of these two pipes respectively;
Item 9. Add a flange connection near the top of the desalinated water storage tank for adding a sight glass, the location should be convenient for the operator to observe the mixing nozzle and spraying conditions;
Item 10. Add a droplet catcher on the exhaust pipe at the top of the storage tank and above the mixing nozzle to capture the water in the supersaturated water vapor in the exhaust and recycle it to the storage tank to reduce the drift loss of desalinated water.

According to Henry's Law Constant, at room temperature, the molar concentrations of hydrogen, oxygen, argon, nitrogen and carbon dioxide dissolved in the desalinated water are 7.9×10⁻¹², 5.0×10⁻⁶, 2.4×10⁻⁷, 9.1×10⁶, and 2.5×10⁷ respectively (see row 4 in data table 11), wherein the argon and nitrogen solutes are completely impossible to be removed by current general water electrolysis plant due to their inert characteristics to chemical reactions.

Since pure water is not electrically conductive, it cannot be used directly for performing water electrolysis. Therefore, electrolytes need to be added to the desalinated water for carrying out water electrolysis. Strong bases are commonly used, such as potassium hydroxide (KOH), sodium hydroxide (NaOH), etc., to turn desalinated water into alkaline; strong acids or salts are less commonly used, such as sulfuric acid (H₂SO₄), nitric acid (HNO₃), etc., to turn desalinated water into acidic or neutral, for increasing the electrical conductivity of desalinated water.

For the more common alkaline water electrolysis process (without the application of the present invention), all the above solutes will all be released along with the hydrogen gas during the water decomposition process on the cathode side of the electrolytic cell, and become impurities in the initial product hydrogen and initial product oxygen. According to the above-mentioned dissolution concentration and the chemical half-reaction on the cathode side, the impurity components of oxygen, argon, nitrogen and carbon dioxide in the initial product hydrogen can reach 4.98 ppmV, 0.24 ppmV, 9.15 ppmV and 0.25 ppmV respectively (see row 6 of data table 11). Since the initial product hydrogen and initial product oxygen will come into contact with the supplementing desalinated water in their respective gas-liquid separators and then mass transfer takes place, part of the impurity in the initial product hydrogen will dissolve back into the desalinated water and diffuse into the initial product oxygen. Depending on the mass transfer effect of the gas-liquid separator, the argon, nitrogen and carbon dioxide taken up by the initial product oxygen can reach 0.16 ppmV, 6.1 ppmV and 0.17 ppmV respectively (see row 6 of data table 12), resulting in the purity of the initial product oxygen being inferior than the requirements of GB/T 14599-2008 for high purity oxygen and ultra pure oxygen.

For the few electrolysis processes using acidic desalinated water or neutral desalinated water (without the application of the present invention), the impurities of oxygen, argon, nitrogen and carbon dioxide released into the initial product hydrogen in the electrolytic cell can be as high as 3.32 ppmV, 0.16 ppmV, 6.10 ppmV and 0.17 ppmV respectively (see row 6 of data table 13). And the impurities of argon, nitrogen and carbon dioxide released into the initial product oxygen can be as high as 0.48 ppmV, 18.30 ppmV and 0.50 ppmV respectively (see row 6 of data table 14). These are inferior to the requirements of GB/T 3634.2-2011 for high pure/ultrapure hydrogens and GB/T 14599-2008 for high purity/ultra pure oxygens.

In summary, before atomization and stripping are performed on the desalinated water, the impurity components in the desalinated water, in the crude hydrogen and in the crude oxygen that are just leaving their respective gas-liquid separator outlets (including the desalinated water is alkaline, acidic or neutral) are summarized in Table 1 below:

TABLE 1
Maximum impurity content - Desalinated water without stripping, ppmV

| Impurity components | | H₂ | O₂ | Ar | N2 | CO | CO₂ | CH₄ |
|---|---|---|---|---|---|---|---|---|
| In desalinated water | | 0.00 | 4.98 | 0.24 | 9.15 | 0.00 | 0.25 | 0.00 |
| Alkaline | in crude H₂ | — | 4.98 | 0.24 | 9.15 | 0.00 | 0.25 | 0.00 |
| | in crude O₂ | 0.00 | — | 0.16 | 6.10 | 0.00 | 0.17 | 0.00 |
| Acidic or neutral | in crude H₂ | — | 3.32 | 0.16 | 6.10 | 0.00 | 0.17 | 0.00 |
| | in crude O₂ | 0.00 | — | 0.48 | 18.30 | 0.00 | 0.50 | 0.00 |

The present invention preferably uses the product hydrogen gas self-produced by water electrolysis process:

First, to atomize and strip the desalinated water to diffuse the air components (including argon and nitrogen) dissolved in the desalinated water into the surrounding hydrogen gas medium, and

Second, to provide a slightly-positive pressure blanketing environment for the stripped desalinated water to prevent air from entering the storage tank and to avoid polluting the desalinated water for a second time due to air dissolving into it.

Hydrogen gas being used for pretreating desalinated water, preferably is self-produced product gas from the water electrolysis plant. However, depending on the actual supply and demand and the performance of the deoxygenation/dehydrogenation units at that time, self-produced oxygen, and hydrogen and oxygen supplied from external rather than from the plant can also be used as a substitute option. For example, when ultra-pure oxygen is the main demand product and the performance of the deoxygenation unit on the hydrogen side is ideal, self-produced oxygen will be a more suitable stripping gas because the crude oxygen produced after oxygen stripping pretreatment will contain impurity hydrogen, argon, nitrogen, carbon monoxide, carbon dioxide and methane all at levels ≤0.1 ppmV (see Table 12, row 30). On the contrary, if self-produced hydrogen is selected as stripping gas, the impurity hydrogen of crude oxygen can increase to 28.4 ppmV (see Table 13, row 30), increasing the load of the subsequent dehydrogenation unit. If the performance of the dehydrogenation unit is not ideal, it may cause the hydrogen impurity component in the product oxygen to be inferior to the target component requirement. If it is required to use hydrogen and oxygen supplied from external rather than from the plant as stripping gas, it is recommended to use hydrogen gas that meets or exceeds the pure hydrogen specifications of GB/T 3634.2-2011 and oxygen gas that meets or exceeds the pure oxygen specifications of GB/T 14599-2008 respectively. However, self-produced product gas is preferably selected as stripping gas, the main reasons include its specifications being better than ultra-pure hydrogen/oxygen, stable purity, no need for external purchase and additional installation of externally-supplied gas systems, no risk of supply interruption, and no risk of contamination due to transportation and filling connections.

The calculation formulas in Tables 7 to 10 provided hereinafter are formulas derived according to the relationship between the entering and exiting each apparatus by considering different types of desalinated water and stripping gas and their water electrolysis chemical reactions in FIGS. 10 to 17. For example, FIG. 10 is the relationship between gas and liquid entering and exiting each apparatus under the conditions of desalinated water being alkaline and self-produced hydrogen as stripping gas, wherein it is mainly divided into 3 parts: [1] is the storage tank (desalinated water) 101, [2] is part comprising the gas-liquid separator (hydrogen side) 301 and cooling/droplet catching/gas-liquid separating apparatus (hydrogen side) 401, and gas-liquid separator (oxygen side) 311 and cooling/droplet catching/gas-liquid separating apparatus (oxygen side) 411, [3] is electrolytic cell 201, taking into account the material balance entering and exiting said 3 parts and the chemical reactions, thereby deriving the formulas of equations 1 to 22 in table 7 provided hereinafter. Among them, when producing product hydrogen, [2] under the condition of zero mass transfer, the impurity concentration in crude hydrogen maintains the highest value, as shown in Table 7 provided hereinafter, Equation 21: V/L=(x₀−y)/(K_{H}^{px}×y/P₁−y₀) can calculate the minimum vapor-liquid ratio required to meet the target impurity concentration requirement, which means that the vapor-liquid ratio of stripping gas to desalinated water is required to be greater than or equal to this value in order to produce product hydrogen containing less than or equal to said target impurity concentration requirement; when producing product oxygen, [2] under the condition of maximum mass transfer, the amount of impurity transferred to crude oxygen is the largest, making the impurity concentration in crude oxygen the highest, as shown in Table 7 provided hereinafter, Equation 16: V/L=(x₀−1.5y)/(K_{H}^{px}×1.5y/P₁−y₀) can calculate the minimum vapor-liquid ratio required to meet the target impurity concentration requirement, which means the vapor-liquid ratio of stripping gas to desalinated water is required to be greater than or equal to this value in order to produce product oxygen containing less than or equal to said target impurity concentration requirement.

For example, FIG. 11 is a relationship diagram of gas and liquid entering and exiting each apparatus under the conditions that desalinated water is alkaline and self-produced oxygen as stripping gas, deriving the formulas of equations 1 to 22 in Table 8 provided hereinafter. Among them, when producing product hydrogen, [2] under the condition of zero mass transfer, the impurity concentration in crude hydrogen maintains the highest value, as shown in Table 8 provided hereinafter, Equation 21: V/L=(x₀−y)/(K_{H}^{px}×y/P₁−y₀) can calculate the minimum vapor-liquid ratio required to meet the target impurity concentration requirement, which means that the vapor-liquid ratio of stripping gas to desalinated water is required to be greater than or equal to this value in order to produce product hydrogen containing less than or equal to said target impurity concentration requirement; when producing product oxygen, [2] under the condition of maximum mass transfer, the amount of impurity transferred to crude oxygen is the largest, making the impurity concentration in crude oxygen the highest, as shown in Table 8 provided hereinafter, Equation 16: V/L=(x₀−1.5y)/(K_{H}^{px}×1.5y/P₁−y₀) can calculate the minimum vapor-liquid ratio required to meet the target impurity concentration requirement, which means the vapor-liquid ratio of stripping gas to desalinated water is required to be greater than or equal to this value in order to produce product oxygen containing less than or equal to said target impurity concentration requirement.

For example, FIG. 12 is a relationship diagram of gas and liquid entering and exiting each apparatus under the conditions that desalinated water as acidic/neutral and self-produced hydrogen as stripping gas, corresponding to the formulas in Table 9 provided hereinafter. Among them, when producing product oxygen, [2] under the condition of zero mass transfer, the impurity concentration in crude oxygen maintains the highest value, as shown in Table 9 provided hereinafter, Equation 21: V/L=(x₀−0.5y)/(K_{H}^{px}×0.5y/P₁−y₀) can calculate the minimum vapor-liquid ratio required to meet the target impurity concentration requirement, which means that the vapor-liquid ratio of stripping gas to desalinated water is required to be greater than or equal to this value in order to produce product oxygen containing less than or equal to said target impurity concentration requirement; when producing product hydrogen, [2] under the condition of maximum mass transfer, the amount of impurity transferred to crude hydrogen is the largest, so that the impurity concentration in crude hydrogen is the highest, as shown in table 9 provided hereinafter, Equation 16: V/L=(x₀−1.5y)/(K_{H}^{px}×1.5y/P₁−y₀) can calculate the minimum vapor-liquid ratio required to meet the target impurity concentration requirement, which means the vapor-liquid ratio of stripping gas to desalinated water is required to be greater than or equal to this value in order to produce product hydrogen containing less than or equal to said target impurity concentration requirement.

For example, FIG. 13 is a relationship diagram of gas and liquid entering and exiting each apparatus under the conditions that desalinated water as acidic/neutral and self-produced oxygen as stripping gas, corresponding to the formulas in Table 10 provided hereinafter. Among them, when producing product oxygen, [2] under the condition of zero mass transfer, the impurity concentration in crude oxygen maintains the highest value, as shown in Table 10 provided hereinafter, Equation 21: V/L=(x₀−0.5y)/(K_{H}^{px}×0.5y/P₁−y₀) can calculate the minimum vapor-liquid ratio required to meet the target impurity concentration requirement, which means that the vapor-liquid ratio of stripping gas to desalinated water is required to be greater than or equal to this value in order to produce product oxygen containing less than or equal to said target impurity concentration requirement; when producing product hydrogen, [2] under the condition of maximum mass transfer, the amount of impurity transferred to crude hydrogen is the largest, so that the impurity concentration in crude hydrogen is the highest, as shown in table 10 provided hereinafter, Equation 16: V/L=(x₀−1.5y)/(K_{H}^{px}×1.5y/P₁−y₀) can calculate the minimum vapor-liquid ratio required to meet the target impurity concentration requirement, which means the vapor-liquid ratio of stripping gas to desalinated water is required to be greater than or equal to this value in order to produce product hydrogen containing less than or equal to said target impurity concentration requirement.

FIG. 14 is a relationship diagram of the gas and liquid entering and exiting each apparatus under the condition that desalinated water as alkaline and externally-supplied hydrogen as stripping gas. Compared with FIG. 10, just change the self-produced hydrogen to externally-supplied hydrogen, in the case where the chemical reaction of water electrolysis remains unchanged, the formula in table 7 provided hereinafter is applicable to this case.

FIG. 15 is a relationship diagram of the gas and liquid entering and exiting each apparatus under the condition that desalinated water is alkaline and externally-supplied oxygen as stripping gas. Compared with FIG. 11, it is just changing the self-produced oxygen to externally-supplied oxygen, in the case where the chemical reaction of water electrolysis remains unchanged, the formula in table 8 provided hereinafter is applicable to this case.

FIG. 16 is a relationship diagram of the gas and liquid entering and exiting each apparatus under the condition that desalinated water as acidic/neutral and externally-supplied hydrogen as stripping gas. Compared with FIG. 12, it is just changing the self-produced hydrogen to externally-supplied hydrogen, in the case where the chemical reaction of water electrolysis remains unchanged, the formula in table 9 provided hereinafter is applicable to this case.

FIG. 17 is a relationship diagram of the gas and liquid entering and exiting each apparatus under the condition that desalinated water as acidic/neutral and externally-supplied oxygen as stripping gas. Compared with FIG. 13, it is just changing the self-produced oxygen to externally-supplied oxygen, in the case where the chemical reaction of water electrolysis remains unchanged, the formula in table 10 provided hereinafter is applicable to this case.

To ensure that the product gases can reach the specifications of ultra-pure hydrogen and ultra-pure oxygen, the minimum amount of gas used for atomization and stripping can be based on whether the desalinated water in the water electrolysis process is alkaline or acidic, and whether the stripping gas is self-produced hydrogen or self-produced oxygen, externally-supplied hydrogen or externally-supplied oxygen, according to FIGS. 10 to 17, the relationship of gas and liquid entering and exiting each apparatus under various specified conditions is shown, sorting out the calculation formulas in Tables 7 to 10 provided hereinafter, thereby obtaining the data tables in Tables 11 to 18 provided hereinafter. Select the corresponding data and calculation tables from Tables 11 to 18 provided hereinafter, in the selected table, row 16 gives the minimum amount of atomization and stripping gas required to produce ultra-pure hydrogen, and row 28 gives the minimum amount of atomization and stripping gas required to produce the ultra-pure oxygen.

The present invention uses hydrogen, through a mixing nozzle, to perform atomization of desalinated water, creating a large area gas liquid mass transfer interface, rendering the mass transfer process to achieve a sufficient equilibrium, maximizing the stripping efficiency. The droplet diameter requirement of the mixing nozzle should be as small as possible. The adjustable range should be 50 to 200 micrometers, but no less than 100 micrometers is recommended to avoid incurring excessive drift losses. The internal structure of the mixing nozzle is recommended to select air flow and liquid flow to have separate individual passages. The two fluids are mixed and collided only outside the nozzle, so that the individual flow rates can be independently and accurately controlled.

In case a purity problem occurs in ultra-pure gas production, it is often needed to stop the production for several days to carry out apparatus maintenance and pipe purging. Therefore, redundant purification measures are generally widely accepted and even demanded by the industry, in particular when the gas is used in the semiconductor industry. Therefore, the present invention besides adds an aeration pipe bubbling in hydrogen gas near the bottom of the storage tank, providing one redundant stripping for the desalinated water as an insurance measure to reduce sudden purity deterioration incident due to performance deterioration of the mixing nozzle atomization, setting drift of hydrogen gas pressure regulating valve, and orifice blockage of hydrogen gas flow rate regulating valve, etc.

Currently, for general water electrolysis plant, the desalinated water replenishment of its storage tank mostly adopts the mode of liquid level control and batch replenishment. During high liquid level periods, which are generally set at 95% of the water capacity of the container to avoid overflowing, the liquid level switch valve feeding water to the storage tank is closed automatically through a liquid level switch. In order to save the hydrogen gas consumption, simultaneous interlock-closure on the hydrogen gas used for atomizing and stripping desalinated water is recommended, achieved by adding a set of liquid level switch valve on the hydrogen gas pipe supplying the mixing nozzle and connecting the pneumatic control signal line to the above-mentioned liquid level switch. However, under the condition where when the hydrogen gas for atomization and stripping is being interlocked to close, desalinated water will still be constantly pumped from the storage tank to the gas-liquid separator, in order to ensure that the storage tank can maintain a slightly-positive pressure blanketing environment, the present invention uses hydrogen gas (volume to volume) not less than the flow rate of desalinated water for bubbling into the desalinated water storage tank through an aeration pipe, filling up the void volume generated by the desalinated water being pumped away. Take 100 L/h desalinated water (equivalent to about 124 Nm³/h hydrogen gas production output) as an example, the hydrogen gas used for bubbling is not less than 100 NL/h (0.1 Nm³/h, that is, the ratio of the amount of hydrogen used for bubbling to the flow rate of desalinated water (the mole-to-mole ratio) is not less than 8.037×10⁻⁰⁴:1.

To effectively prevent air from entering the storage tank by diffusion, the blanketing pressure should not be less than 250 N/m².

In order to further ensure that air cannot enter the desalinated water storage tank, the present invention arranges a check valve at the discharge pipe at the top of the storage tank and on the pipe between the droplet catcher outlet and the flame arrester to prevent air from diffusing into the storage tank. The opening pressure of the check valve also provides a stable blanketing slightly-positive pressure to the desalinated water storage tank. According to the requirements of the previous paragraph, the specification of the check valve opening pressure should not be less than 250 N/m².

Using alkaline water electrolysis to produce hydrogen as an example, after atomizing and stripping the desalinated water by using self-produced hydrogen with a vapor-liquid ratio of 0.00092 mol/mol, the concentrations of hydrogen, oxygen, argon, nitrogen, carbon monoxide, carbon dioxide and methane dissolved in it remain 1.4×10⁻⁵, 1.3×10⁻⁰⁷, 6.5×10⁻⁰⁹, 1.2×10⁻⁰⁷, 1.7×10⁻¹⁴, 1.0×10⁻¹² and 1.3×10⁻¹², respectively, unit is mole fraction mol/mol. After the stripped desalinated water enters the electrolytic cell, it is decomposed into OH and hydrogen gas at the cathode side, all the oxygen, argon, nitrogen, carbon monoxide, carbon dioxide and methane are also released along with the decomposed hydrogen, they constitute the main impurities in the product hydrogen together with saturated water. According to the stoichiometry of water electrolysis, the impurity components in example above in the product hydrogen are respectively 0.13 ppmV, 0.01 ppmV, 0.12 ppmV, 0.00 ppmV, 0.10 ppmV and 0.00 ppmV (see Table 11, row 18), which meets already the National Standards of the People's Republic of China for the requirements of ultrapure hydrogen. However, a very small amounts of oxygen molecules will infiltrate from the anode side through the separating diaphragm into the product hydrogen on the cathode side by osmosis. Therefore, the hydrogen gas at this stage still needs to go through conventional catalytic deoxygenation, condensation drainage and molecular sieve adsorption drying, completely removing the trace amounts of impurity oxygen and water, making the product hydrogen fully meet the technical requirements of GB/T 3634.2-2011 for ultrapure hydrogen.

As a preferred technical solution for the pretreatment method of preparing ultra-pure hydrogen/oxygen, pipes are arranged at said hydrogen buffer tank outlet, the oxygen buffer tank outlet, and the externally-supplied gas connector to connect to a four-way valve, to facilitate selecting self-produced hydrogen, self-produced oxygen, externally-supplied hydrogen or externally-supplied oxygen as stripping gas, and externally-supplied nitrogen for displacement purging.

As a preferred technical solution for the pretreatment method for preparing ultra-pure hydrogen/oxygen, the minimum flow rate ratio (vapor-liquid ratio) of stripping gas to desalinated water is listed in Table 2 below:

TABLE 2
Minimum vapor-liquid ratio (V/L, mol/mol)

| | | Specification | |
|---|---|---|---|
| | | Ultra- | Ultra- |
| Desalinated water | Stripping gas | pure H₂ | pure O₂ |
| Alkaline | Self-produced H₂ | 0.00092 | 0.00070 |
| | Self-produced O₂ | 0.00092 | 0.00070 |
| | Externally-supplied pure H₂ | 0.00095 | 0.00071 |
| | Externally-supplied pure O₂ | 0.00092 | 0.00070 |
| Acidic or neutral | Self-produced H₂ | 0.00041 | 0.00244 |
| | Self-produced O₂ | 0.00041 | 0.00244 |
| | Externally-supplied pure H₂ | 0.00042 | 0.00260 |
| | Externally-supplied pure O₂ | 0.00041 | 0.00247 |

When the main demand is at or above the specification of ultra-pure hydrogen, the present invention does not recommend using oxygen gas (self-produced or externally-supplied) for stripping and pressure maintenance purposes, mainly because if oxygen gas is used, the concentration of oxygen dissolved in the desalinated water after stripping will increase by 368% compared with that before stripping, causing the oxygen impurity component in crude hydrogen to reach 23.33 ppmV (see row 18 in Table 12), seriously increasing the load on the subsequent deoxygenation unit. On the contrary, after using self-produced hydrogen for stripping, the dissolved oxygen concentration in water will be reduced by 97%, causing the oxygen impurity component in crude hydrogen to decrease to 0.13 ppmV (see Table 11, row 18), greatly reducing the load on the deoxygenation unit. This allows the entire catalytic capacity to be used for removing the trace oxygen molecules that infiltrate across the separator membrane through osmosis and enter into crude hydrogen at the cathode side, and the trace oxygen molecules that diffuse from desalinated water into crude hydrogen in the separator, ensuring the purity requirements of product hydrogen.

Conversely, when the main demand is at or above the specification of ultra-pure oxygen, the present invention accepts the selection of using oxygen gas (self-produced or externally-supplied) for stripping and pressure maintenance purposes, mainly because if hydrogen is used, the hydrogen concentration dissolved in desalinated water after stripping will increase to 1.4×10⁻⁵ mol/mol, causing the hydrogen impurity component in crude oxygen to reach 9.33 ppmV (see Table 11, row 30), slightly increasing the load on the subsequent dehydrogenation unit. On the contrary, after using self-produced oxygen for stripping, the dissolved hydrogen concentration in water will be reduced to 1.6×10⁻¹³ mol/mol, causing the hydrogen impurity component in crude oxygen to decrease to 0.00 ppmV (see Table 12, row 30), greatly reducing the load on the dehydrogenation unit. This allows the entire catalytic capacity to be used for removing the trace hydrogen molecules that infiltrate across the separator membrane through osmosis and enter into crude oxygen at the anode side, and trace hydrogen molecules that diffuse from the supplementing desalinated water into the oxygen gas in the gas-liquid separator, ensuring the purity requirements of product oxygen.

The present invention can not only economically upgrade the products of water electrolysis process to ultra-pure hydrogen and ultra-pure oxygen, the impurity components of argon, nitrogen, carbon monoxide, carbon dioxide and methane in the product gases can be further reduced by increasing the usage amount of atomization and stripping gas, that is, increasing the vapor-liquid ratio (V/L) of stripping gas to desalinated water, thereby improving the purity specifications of the product gases, rendering them superior to the aforementioned ultra-pure hydrogen and ultra-pure oxygen. The minimum usage amount of atomization and stripping gas required can also be determined based on whether the desalinated water in the water electrolysis process is alkaline, acidic or neutral, and whether the stripping gas is self-produced hydrogen, self-produced oxygen, externally-supplied hydrogen or externally-supplied oxygen, selecting the corresponding data and calculation tables from tables 11 to 18 provided hereinafter as template, entering the target component of the product gas of the customized hydrogen and customized oxygen in rows 8 and 20 respectively, and calculating step by step, line 16 gives the minimum usage amount of atomization and stripping gas required to produce the customized hydrogen, and line 28 gives the minimum usage amount of atomization and stripping gas required to produce the customized oxygen. The trend curve in FIG. 8 shows the relationship between the amount of impurity in crude hydrogen and the change in vapor-liquid ratio when using self-produced hydrogen as stripping gas in alkaline water electrolysis, and also highlights that the change of the minimum vapor-liquid ratio required for improving ultra-pure hydrogen (UPH) to customized hydrogen (XPH, taking all target impurities in hydrogen ≤50 ppbV as an example) changes from 0.00092 mol/mol to 0.00244 mol/mol. The trend curve in FIG. 9 shows the relationship between the amount of impurity in crude oxygen and the change in vapor-liquid ratio when using self-produced hydrogen as stripping gas in alkaline water electrolysis, and also highlights that the change of the minimum vapor-liquid ratio required for improving ultra-pure oxygen (UPO) to customized oxygen (XPO, taking all target impurities in oxygen ≤50 ppbV as an example) changes from 0.00070 mol/mol to 0.00143 mol/mol.

Taking specially customized product hydrogen and specially customized product oxygen with all target impurities ≤50 ppbV as an example, the minimum vapor-liquid ratio is shown in Table 3 below:

TABLE 3
Minimum vapor-liquid ratio (V/L, mol/mol)

| | | Spec. | |
|---|---|---|---|
| | | Customized H₂ | Customized O₂ |
| Desalinated water | Stripping gas | (e.g.: All impurities ≤50 ppbV) | |
| Alkaline | Self-produced H₂ | 0.00244 | 0.00143 |
| | Self-produced O₂ | 0.00244 | 0.00143 |
| | Externally-supplied pure H₂ | 0.00260 | 0.00149 |
| | Externally-supplied pure O₂ | 0.00247 | 0.00144 |
| Acidic or neutral | Self-produced H₂ | 0.00156 | 0.00549 |
| | Self-produced O₂ | 0.00143 | 0.00549 |
| | Externally-supplied pure H₂ | 0.00156 | 0.00624 |
| | Externally-supplied pure O₂ | 0.00144 | 0.00562 |

### BRIEF DESCRIPTION OF THE DRAWINGS

The present invention is further described below in conjunction with the drawings and embodiments.

FIG. 1 is an overview diagram of the current conventional industrial water electrolysis process;

FIG. 2 is an overall integration diagram of embodiment 1 of the present invention according to self-produced hydrogen as stripping gas and a conventional water electrolysis plant;

FIG. 3 is a detailed process modification diagram of embodiment 1 of the present invention according to self-produced hydrogen as stripping gas;

FIG. 4 is an overall integration diagram of embodiment 2 of the present invention according to self-produced oxygen as stripping gas and a conventional water electrolysis plant;

FIG. 5 is a detailed process modification diagram of embodiment 2 of the present invention according to self-produced oxygen as stripping gas;

FIG. 6 is an overall integration diagram of embodiment 3 of the present invention according to externally-supplied hydrogen/oxygen as stripping gas and a conventional water electrolysis plant;

FIG. 7 is a detailed process modification diagram of embodiment 3 of the present invention according to externally-supplied hydrogen/oxygen as stripping gas;

FIG. 8 is a trend chart of the amount of impurity in crude hydrogen against the change in vapor-liquid ratio, in which alkaline water electrolysis uses self-produced hydrogen as stripping gas;

FIG. 9 is a trend chart of the amount of impurity in crude oxygen against the change in vapor-liquid ratio, in which alkaline water electrolysis uses self-produced hydrogen as stripping gas;

FIG. 10 is a relationship diagram of the gas and liquid entering and exiting each apparatus under the condition that desalinated water is alkaline, self-produced hydrogen as stripping gas;

FIG. 11 is a relationship diagram of the gas and liquid entering and exiting each apparatus under the condition that desalinated water is alkaline, self-produced oxygen as stripping gas;

FIG. 12 is a relationship diagram of the gas and liquid entering and exiting each apparatus under the condition that desalinated water is acidic/neutral, self-produced hydrogen as stripping gas;

FIG. 13 is a relationship diagram of the gas and liquid entering and exiting each apparatus under the condition that desalinated water is acidic/neutral, self-produced oxygen as stripping gas;

FIG. 14 is a relationship diagram of the gas and liquid entering and exiting each apparatus under the condition that desalinated water is alkaline, externally-supplied hydrogen as stripping gas;

FIG. 15 is a relationship diagram of the gas and liquid entering and exiting each apparatus under the condition that desalinated water is alkaline, externally-supplied oxygen as stripping gas;

FIG. 16 is a relationship diagram of the gas and liquid entering and exiting each apparatus under the condition that desalinated water is acidic/neutral, externally-supplied hydrogen as stripping gas;

FIG. 17 is a relationship diagram of the gas and liquid entering and exiting each apparatus under the condition that desalinated water is acidic/neutral, externally-supplied oxygen as stripping gas.

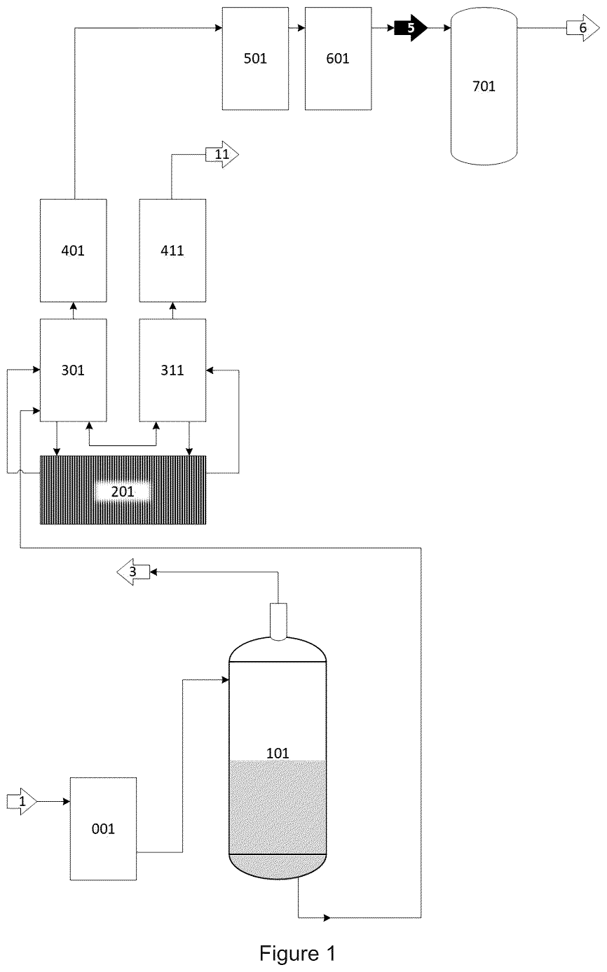

### DESCRIPTION OF EMBODIMENTS

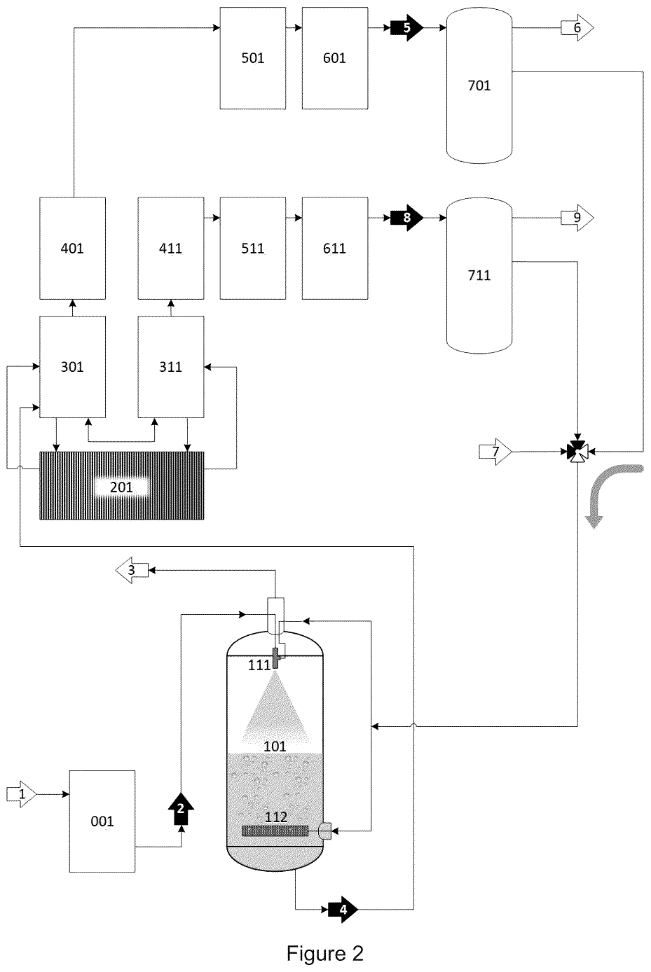

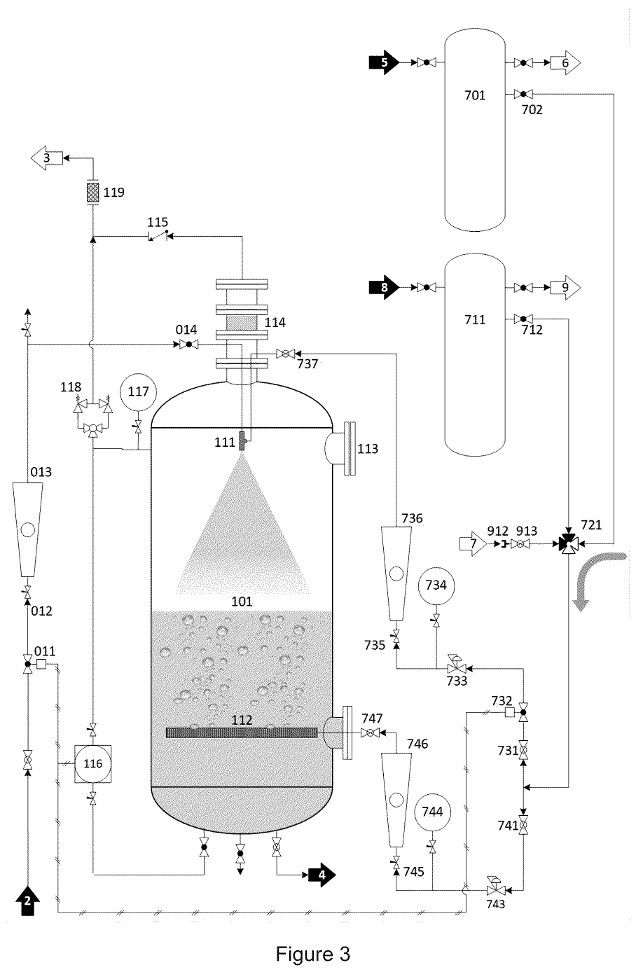

The present invention is to perform a minor modification (see FIG. 2 and FIG. 3) on process design of the conventional industrial water electrolysis process currently commonly used to produce hydrogen gas or on an existing plant already in service so that the product gases can be upgraded from pure hydrogen and pure oxygen to ultra-pure hydrogen and ultra-pure oxygen, or even to product hydrogen and product oxygen with stricter purity specifications or specially customized purity requirements. Considering the different conditions of individual apparatuses and supply and demand, corresponding specific embodiments are proposed:
Example 1. Using self-produced product hydrogen of the water electrolysis plant as the pretreatment gas.
Example 2. Using the self-produced product oxygen of the water electrolysis plant as the pretreatment gas.
Example 3. Using externally-supplied hydrogen gas or oxygen gas as the pretreatment gas.

Among the above three embodiments, embodiments 1 and 2 are more preferred. Because the self-produced product gas of the water electrolysis plant is used as the pretreatment gas, i.e., gas for stripping and/or bubbling, the risk of pretreatment gas supply interruption is eliminated, purity and reasonable cost of pretreatment gas are guaranteed. And the selection between embodiment 1 and embodiment 2 depends on whether the market demand at that time is mainly ultra-pure hydrogen or ultra-pure oxygen, the former is preferably embodiment 1, the latter is preferably embodiment 2.

### EMBODIMENTS

### Embodiment 1

This embodiment (embodiment 1) is based on using self-produced product hydrogen of a water electrolysis plant as the pretreatment gas. The specific implementation method is (see FIGS. 2 and 3):

A flange connection fitting (for easy maintenance, assembly and disassembly) is added on the top of the desalinated water storage tank (101) for installing a mixing nozzle (111) and connecting to stripping gas and desalinated water. The technical specifications of the mixing nozzle (111) are as follows:
Specification 1. The design point of droplet diameter is 100 micrometers, and the adjustable range should be 50 to 200 micrometers.
Specification 2. The gas working design flow rate of the mixing nozzle (111) is the product of the minimum vapor-liquid ratio (V/L) and the desalinated water flow rate (L). Taking alkaline water electrolysis, the target product gas being ultra-pure hydrogen and a desalinated water flow rate of 100 L/h as an example, the minimum vapor-liquid ratio (V/L) should be 0.00092 mol/mol (see Table 11, row 16), multiplied by the desalinated water flow rate of 100 L/h, the design point of gas working flow rate of the mixing nozzle (111) is 0.114 Nm³/h. Taking acidic desalinated water, the target product gas being ultra-pure hydrogen and a desalinated water flow rate of 100 L/h as an example, the minimum vapor-liquid ratio (V/L) is 0.000411 mol/mol (see Table 13, row 16), multiplied by the desalinated water flow rate of 100 L/h, the design point of gas working flow rate of the mixing nozzle (111) is 0.051 Nm³/h.

The desalinated water pipe originally connected to the desalinated water storage tank (101) is changed to connect to the water inlet port of the mixing nozzle (111). If the original design does not have a desalinated water flow rate regulating valve (012) nor a flow rate indicator (013), one should refit at the upstream of the mixing nozzle (111) and on the desalinated water supply pipe to facilitate precise control.

One pipe is added connecting from the gas outlet on-off valve (702) of the product hydrogen buffer tank (701) to the four-way valve (721), with the four-way valve turned to the position for connecting the product hydrogen to the three-way pipe fitting, and through the three-way pipe fitting connecting respectively to the gas inlet port of the mixing nozzle (111) and to the gas inlet port of the aeration pipe (112), before entering the mixing nozzle (111) and the aeration pipe (112), on-off valves (731, 741), pressure regulating valves (733, 743), pressure gauges (734, 744), flow rate regulating valves (735, 745), flow rate indicator (736, 746) and on-off valves (737, 747) are respectively set provided on these two pipes to respectively facilitate accurate regulate of the gas flow rates used for atomization and stripping and for blanketing gas-bubbling desalinated water. The technical design parameters of this part are:
Parameter 1. The gas working design flow rate supplying from the product hydrogen buffer tank (701) to the above-mentioned tee pipe fittings and valves is the minimum vapor-liquid ratio multiplied by the desalinated water flow rate then plus the volume flow rate of the desalinated water. Taking alkaline desalinated water, target product gas being ultra-pure hydrogen and a desalinated water flow rate of 100 L/h as an example, the minimum vapor-liquid ratio (V/L) is 0.00092 mol/mol (see Table 11, row 16), and the comprehensive gas working design flow rate of this section of pipe fittings is 0.214 Nm³/h. Taking acidic desalinated water, target product gas being ultra-pure hydrogen and a desalinated water flow rate of 100 L/h as an example, the minimum vapor-liquid ratio (V/L) is 0.000411 mol/mol (see Table 13, row 16), and the comprehensive gas working design flow rate of this section of pipe fitting is 0.151 Nm³/h.
Parameter 2. The pipe diameter for supplying from the tee to the mixing nozzle (111), the flow rate regulating valve (735), the pressure regulating valve (733) and the flow rate indicator (736), their gas working design flow rates are the minimum vapor-liquid ratio multiplied by the desalinated water flow rate. Taking alkaline desalinated water, target product gas being ultra-pure hydrogen and a desalinated water flow rate of 100 L/h as an example, the minimum vapor-liquid ratio (V/L) is 0.00092 mol/mol (see Table 11, row 16), and the design point of gas flow rate for this section of pipe fitting is 0.114 Nm³/h. Taking acidic desalinated water, target product gas being ultra-pure hydrogen and a desalinated water flow rate of 100 L/h as an example, the minimum vapor-liquid ratio (V/L) is 0.000411 mol/mol (see Table 13, row 16), and the design point of gas flow rate for this section of pipe fitting is 0.051 Nm³/h.
Parameter 3. The pipe diameter for supplying from the tee to the aeration pipe (112), the flow rate regulating valve (745), the pressure regulating valve (743) and the flow rate indicator (746), their gas working design flow rates are the volume flow rate of the desalinated water. Taking a desalinated water flow rate of 100 L/h as an example, the gas working design flow rate of this section of pipe fitting is 0.10 Nm³/h.

A liquid level switch valve (732) is added between the on-off valve (731) and the pressure regulating valve (733) and a pneumatic control signal line is connected to the liquid level indicator and switch (116). During the period when the liquid level of the storage tank (101) is high (the liquid level of the storage tank is set to >95% to avoid overflow), the liquid level switch valve (732) is interlocked to close for saving the gas used for atomization and stripping. Likewise, the gas working design flow rate of the liquid level switch valve (732) is the minimum vapor-liquid ratio multiplied by the desalinated water flow rate. Taking alkaline desalinated water, target product gas being ultra-pure hydrogen and a desalinated water flow rate of 100 L/h as an example, the minimum vapor-liquid ratio (V/L) is 0.00092 mol/mol (see Table 11, row 16), and the gas working design flow rate of this liquid level switch valve is 0.114 Nm³/h. Taking acidic desalinated water, target product gas being ultra-pure hydrogen and a desalinated water flow rate of 100 L/h as an example, the minimum vapor-liquid ratio (V/L) is 0.000411 mol/mol (see Table 13, row 16), and the gas working design flow rate of this liquid level switch valve is 0.051 Nm³/h.

A flange connection is added near the top of the desalinated water storage tank (101) for adding a sight glass (113), the position should be convenient for the operator to inspect the nozzle (111) and the spraying conditions. Add a droplet catcher (114) on the exhaust pipe at the top of the storage tank (101) and above the nozzle to capture water in the supersaturated water vapor in the exhaust and recycle to the storage tank (101) to reduce the drift loss of the desalinated water.

Add a check valve (115) on the pipe of the droplet catcher outlet of the desalinated water storage tank (101) to prevent air from infiltration and to provide a stable blanketing pressure to the desalinated water storage tank (101).

Since hydrogen gas is fed into the storage tank (101), a pressure gauge (117) and a pressure safety valve assembly (118) should be added on the top of the tank to facilitate monitoring of the pressure inside the tank and protect the container from overpressure in the event of failure of the pressure regulating valves (733, 743) and the check valve (115).

The exhaust gases from the desalinated water storage tank (101) and from the pressure safety valve assembly (118) should be collected through a pipe and connected to an outdoor high position and safely discharged through a flame arrester (119).

### Embodiment 2

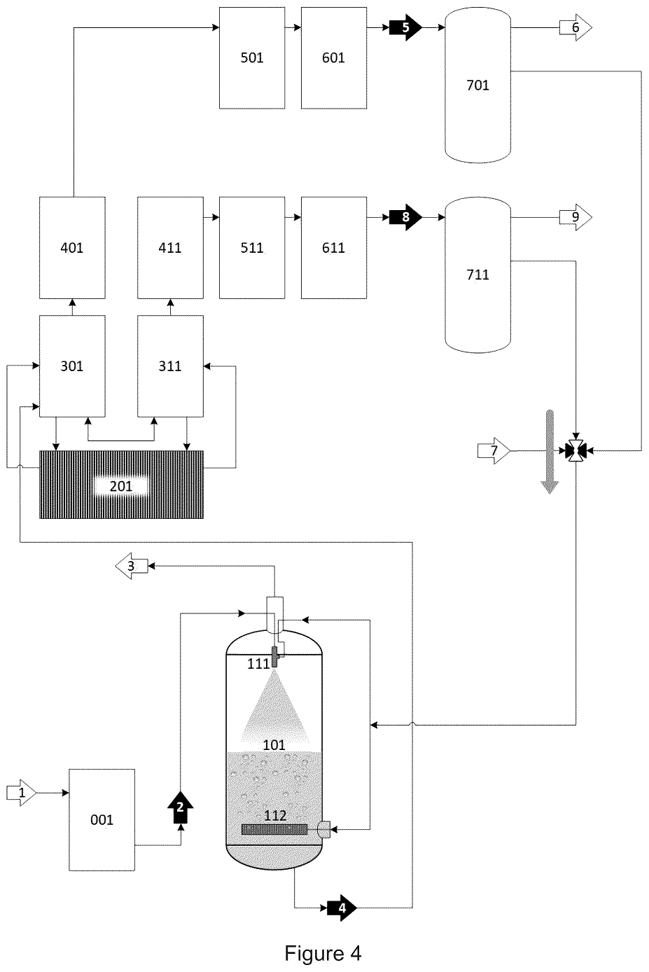

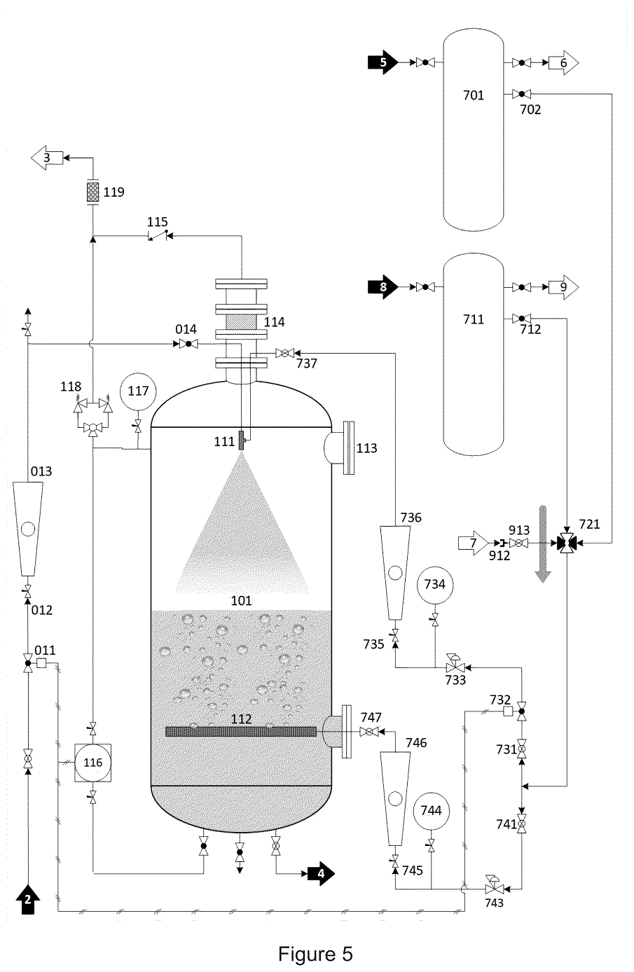

This embodiment (embodiment 2) is based on using the product oxygen self-produced by the water electrolysis plant as the pretreatment gas. The specific implementation method is (see FIGS. 4 and 5):

A flange connection fitting (for easy maintenance, assembly and disassembly) is added on the top of the desalinated water storage tank (101) for installing a mixing nozzle (111) and connecting to stripping gas and desalinated water. The technical specifications of the mixing nozzle (111) are as follows:
Specification 3. The design point of droplet diameter is 100 micrometers, the adjustable range should be 50 to 200 micrometers.
Specification 4. The gas working design flow rate for stripping of the mixing nozzle (111) is the product of the minimum vapor-liquid ratio (V/L) and the desalinated water flow rate (L). Taking alkaline water electrolysis, the product gas being ultra-pure oxygen and a desalinated water flow rate of 100 L/h as an example, the minimum vapor-liquid ratio (V/L) should be 0.000703 mol/mol (see Table 12, row 28), multiplied by the desalinated water flow rate of 100 L/h, the design point of gas working flow rate of the mixing nozzle (111) is 0.088 Nm³/h. Taking acidic desalinated water, the target product gas being ultra-pure oxygen and a desalinated water flow rate of 100 L/h as an example, the minimum vapor-liquid ratio (V/L) is 0.00244 mol/mol (see Table 14, row 28), multiplied by the desalinated water flow rate of 100 L/h, the design point of gas working flow rate of the mixing nozzle (111) is 0.304 Nm³/h.

The desalinated water pipe originally connected to the desalinated water storage tank (101) is changed to connect to the water inlet port of the mixing nozzle (111). If the original design does not have a desalinated water flow rate regulating valve (012) nor a flow rate indicator (013), one should refit at the upstream of the mixing nozzle (111) and on the desalinated water supply pipe to facilitate precise control.

One pipe is added connecting from the gas outlet on-off valve (712) of the product oxygen buffer tank (711) to the four-way valve (721), with the four-way valve turned to the position for connecting the product oxygen to the tee pipe fitting, and through the tee pipe fitting connecting respectively to the gas inlet port of the mixing nozzle (111) and to the gas inlet port of the aeration pipe (112), before entering the mixing nozzle (111) and the aeration pipe (112), on-off valves (731, 741), pressure regulating valves (733, 743), pressure gauges (734, 744), flow rate regulating valves (735, 745), flow rate indicators (736, 746) and on-off valves (737, 747) are respectively set provided on these two pipes to respectively facilitate accurate regulate of the gas flow rates used for atomization and stripping and for blanketing gas-bubbling desalinated water. The technical design parameters of this part are;
Parameter 4. The gas working design flow rate supplying from the product oxygen buffer tank (711) to the above-mentioned tee pipe fittings and valves is the minimum vapor-liquid ratio multiplied by the desalinated water flow rate then plus the volume flow rate of the desalinated water. Taking alkaline desalinated water, target product gas being ultra-pure oxygen and a desalinated water flow rate of 100 L/h as an example, the minimum vapor-liquid ratio (V/L) is 0.000703 mol/mol (see Table 12, row 28), and the comprehensive gas working design flow rate of this section of pipe fittings is 0.188 Nm³/h. Taking acidic desalinated water, target product gas being ultra-pure oxygen and a desalinated water flow rate of 100 L/h as an example, the minimum vapor-liquid ratio (V/L) is 0.00244 mol/mol (see Table 14, row 28), and the comprehensive gas working design flow rate of this section of pipe fitting is 0.404 Nm³/h.
Parameter 5. The pipe diameter supplying from the tee to the mixing nozzle (111), the flow rate regulating valve (735), the pressure regulating valve (733) and the flow rate indicator (736), their oxygen gas working design flow rates are the minimum vapor-liquid ratio multiplied by the desalinated water flow rate. Taking alkaline desalinated water, target product gas being ultra-pure oxygen and a desalinated water flow rate of 100 L/h as an example, the minimum vapor-liquid ratio (V/L) is 0.000703 mol/mol (see Table 12, row 28), and the design point of gas flow rate for this section of pipe fitting is 0.088 Nm³/h. Taking acidic desalinated water, target product gas being ultra-pure oxygen and a desalinated water flow rate of 100 L/h as an example, the minimum vapor-liquid ratio (V/L) is 0.00244 mol/mol (see Table 14, row 28), and the design point of gas flow rate for this section of pipe fitting is 0.304 Nm³/h.
Parameter 6. The pipe diameter supplying from the tee to the aeration pipe (112), the flow rate regulating valve (745), the pressure regulating valve (743) and the flow rate indicator (746), their oxygen gas working design flow rates are the volume flow rate of the desalinated water. Taking a desalinated water flow rate of 100 L/h as an example, the gas working design flow rate of this section of pipe fitting is 0.10 Nm³/h.

A liquid level switch valve (732) is added between the on-off valve (731) and the pressure regulating valve (733) and a pneumatic control signal line is connected to the liquid level indicator and switch (116). During the period when the liquid level of the storage tank (101) is high (the liquid level of the storage tank is set to ≥95% to avoid overflow), the liquid level switch valve (732) is interlocked to close for saving the gas used for atomization and stripping. Likewise, the gas working design flow rate of the liquid level switch valve (732) is the minimum vapor-liquid ratio multiplied by the desalinated water flow rate. Taking alkaline desalinated water, target product gas being ultra-pure oxygen and a desalinated water flow rate of 100 L/h as an example, the minimum vapor-liquid ratio (V/L) should be 0.000703 mol/mol (see Table 12, row 28), and the gas working design flow rate of this liquid level switch valve is 0.088 Nm³/h. Taking acidic desalinated water, target product gas being ultra-pure oxygen and a desalinated water flow rate of 100 L/h as an example, the minimum vapor-liquid ratio (V/L) is 0.00244 mol/mol (see Table 14, row 28), and the gas working design flow rate of this liquid level switch valve is 0.304 Nm³/h.

A flange connection is added near the top of the desalinated water storage tank (101) for adding a sight glass (113), the position should be convenient for the operator to inspect the nozzle (111) and the spraying conditions. Add a droplet catcher (114) on the exhaust pipe at the top of the storage tank (101) and above the nozzle to capture water in the supersaturated water vapor in the exhaust and recycle to the storage tank (101) to reduce the drift loss of the desalinated water.

Add a check valve (115) on the pipe of the droplet catcher outlet of the desalinated water storage tank (101) to prevent air from infiltration and to provide a stable blanketing pressure to the desalinated water storage tank (101).

Since oxygen gas is fed into the storage tank (101), a pressure gauge (117) and a pressure safety valve assembly (118) should be added on the top of the tank to facilitate monitoring of the pressure inside the tank and protect the container from overpressure in the event of failure of the pressure regulating valves (733, 743) and the check valve (115).

The exhaust gases from the desalinated water storage tank (101) and from the pressure safety valve assembly (118) should be collected through a pipe and connected to an outdoor high position and safely discharged through a flame arrester (119).

### Embodiment 3

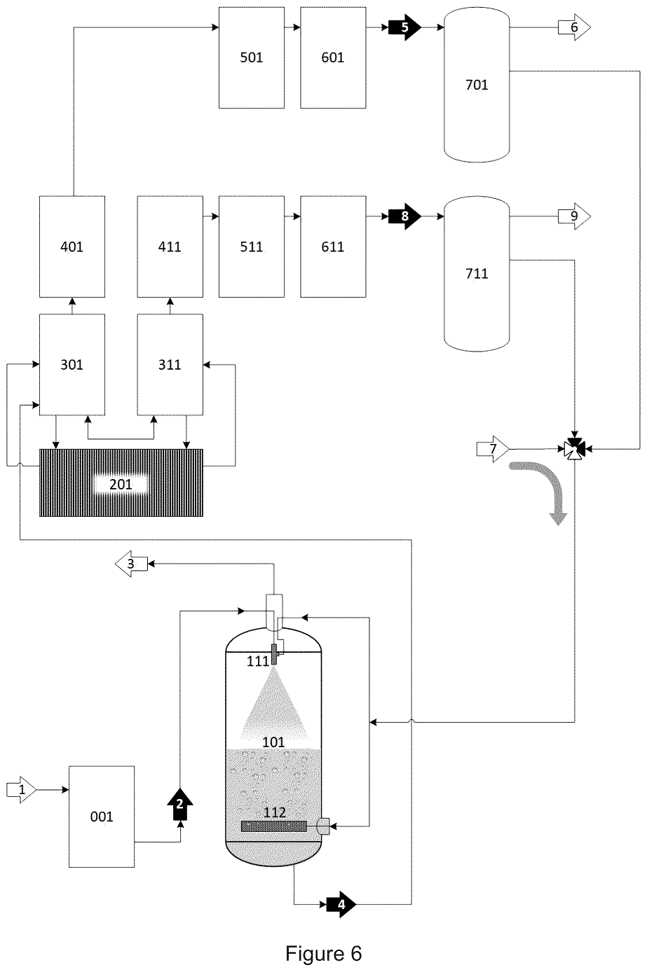

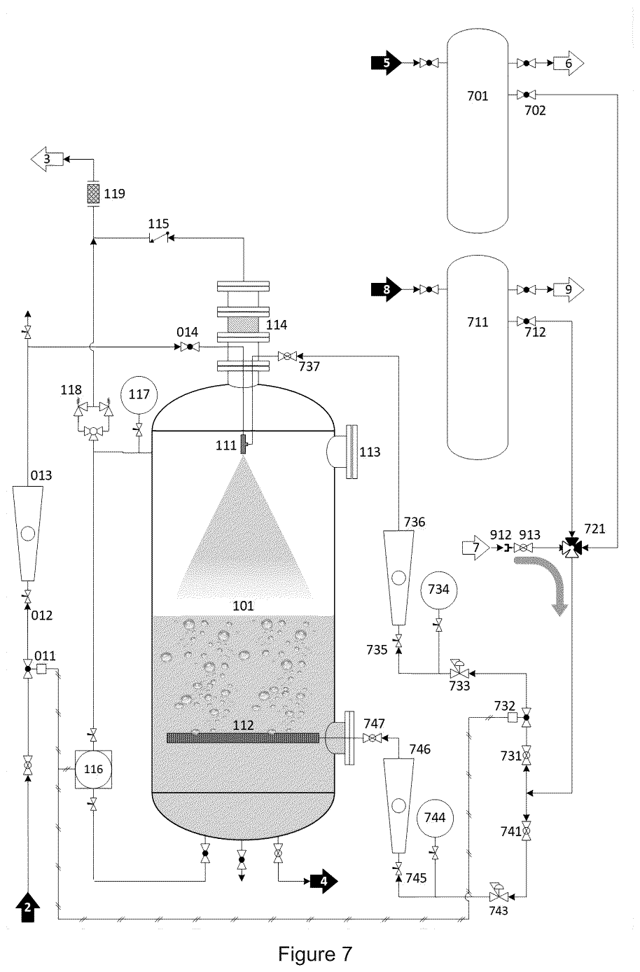

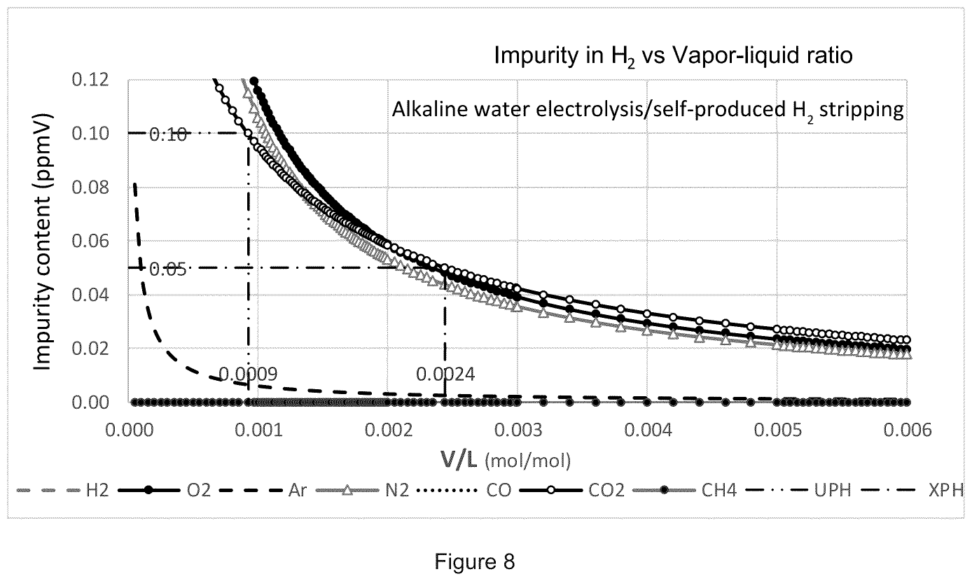

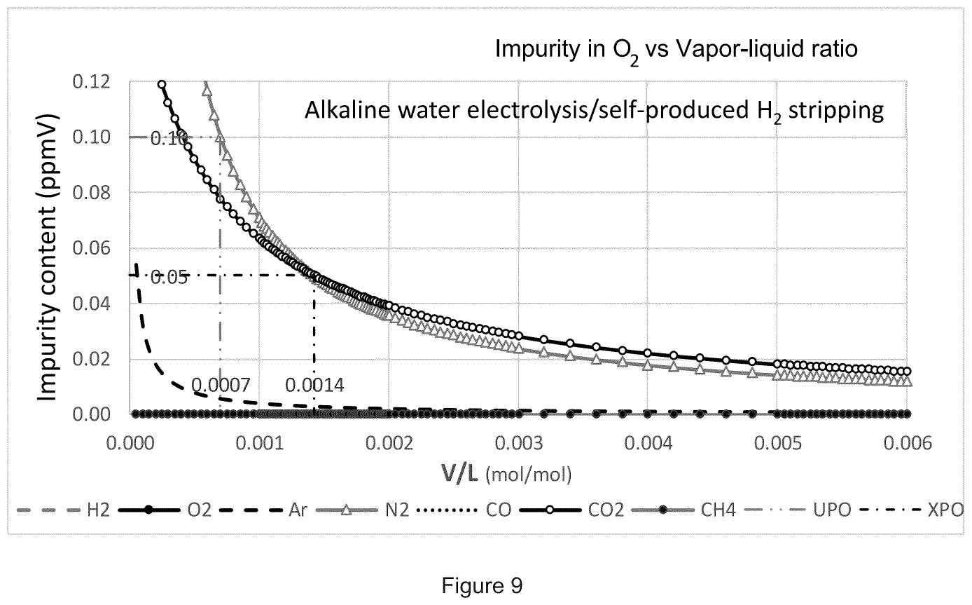

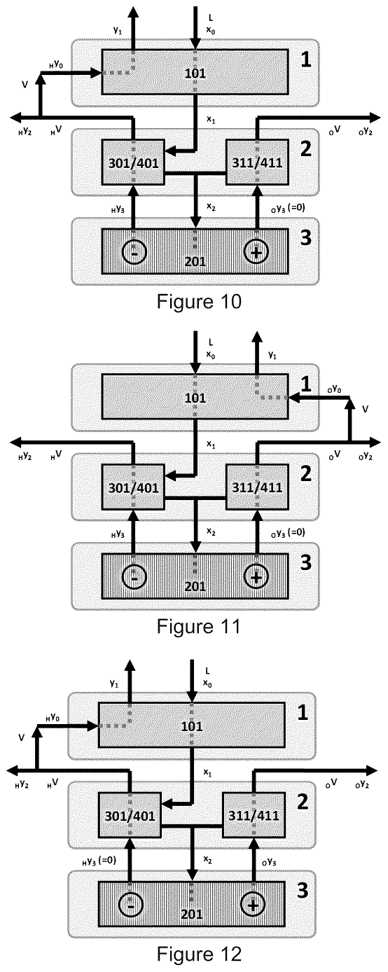

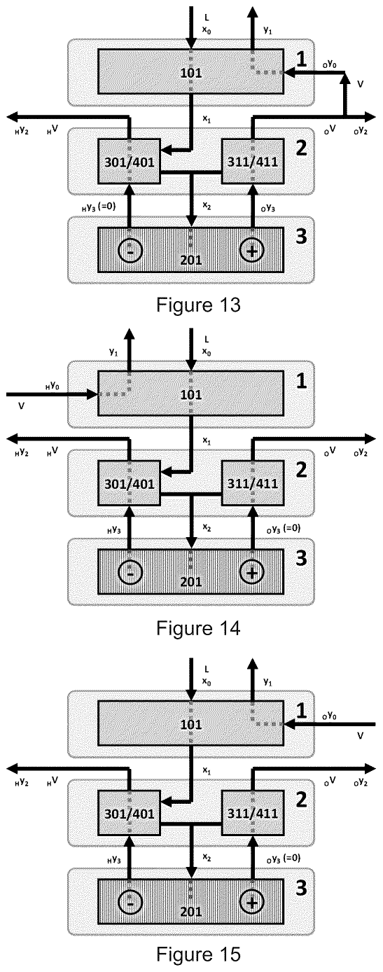

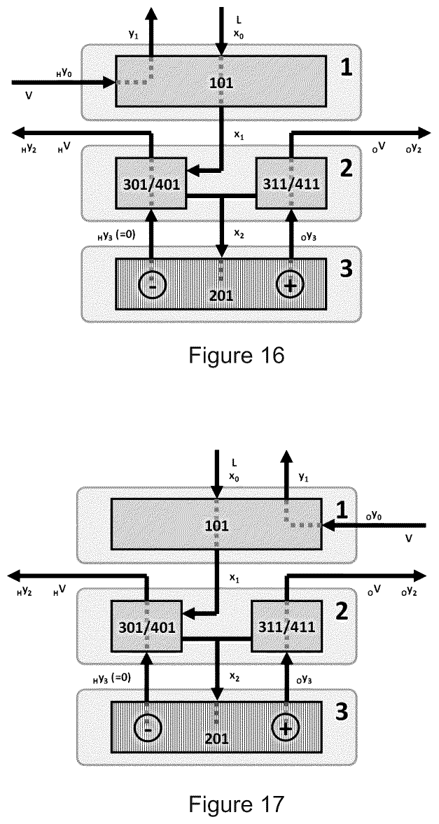

This embodiment (embodiment 3) is based on using water electrolysis plant, externally-supplied gas (pure hydrogen) as the pretreatment gas. The specific implementation method is (see FIGS. 6 and 7):

A flange connection fitting (for easy maintenance, assembly and disassembly) is added on the top of the desalinated water storage tank (101) for installing a mixing nozzle (111) and connecting to stripping gas and desalinated water. The technical specifications of the mixing nozzle (111) are as follows:
Specification 5. The design point of droplet diameter is 100 micrometers, and the adjustable range should be 50 to 200 micrometers.
Specification 6. The gas working design flow rate of the mixing nozzle (111) is the product of the minimum vapor-liquid ratio (V/L) and the desalinated water flow rate (L). Taking alkaline water electrolysis, the product gas being ultra-pure hydrogen and a desalinated water flow rate of 100 L/h as an example, the minimum vapor-liquid ratio (V/L) should be 0.000947 mol/mol (see Table 15, row 16), multiplied by the desalinated water flow rate of 100 L/h, the design point of gas working flow rate of the mixing nozzle (111) is 0.118 Nm³/h. Taking acidic desalinated water, the target product gas being ultra-pure hydrogen and a desalinated water flow rate of 100 L/h as an example, the minimum vapor-liquid ratio (V/L) is 0.000419 mol/mol (see Table 17, row 16), multiplied by the desalinated water flow rate of 100 L/h, the design point of gas working flow rate of the mixing nozzle (111) is 0.052 Nm³/h.

The desalinated water pipe originally connected to the desalinated water storage tank (101) is changed to connect to the water inlet port of the mixing nozzle (111). If the original design does not have a desalinated water flow rate regulating valve (012) nor a flow rate indicator (013), one should refit at the upstream of the mixing nozzle (111) and on the desalinated water supply pipe to facilitate precise control.

One pipe is added connecting from the externally-supplied connector (912) and on-off valve (913) outlet to the four-way valve (721), with the four-way valve turned to the position for connecting the externally-supplied gas to the tee pipe fitting, and through the tee pipe fitting connecting respectively to the gas inlet port of the mixing nozzle (111) and to the gas inlet port of the aeration pipe (112), before entering the mixing nozzle (111) and the aeration pipe (112), on-off valves (731, 741), pressure regulating valves (733, 743), pressure gauges (734, 744), flow rate regulating valves (735, 745), flow rate indicator (736, 746) and on-off valves (737, 747) are respectively set provided on these two pipes to respectively facilitate accurate regulate of the gas flow rates used for atomization and stripping and for blanketing gas-bubbling desalinated water. The technical design parameters of this part are;
Parameter 7. The gas working design flow rate supplying from the externally-supplied connector (912) and on-off valve (913) outlet to the above-mentioned tee pipe fittings and valves is the minimum vapor-liquid ratio multiplied by the desalinated water flow rate then plus the volume flow rate of the desalinated water. Taking alkaline desalinated water, target product gas being ultra-pure hydrogen and a desalinated water flow rate of 100 L/h for producing ultra-pure hydrogen as an example, the minimum vapor-liquid ratio (V/L) is 0.000947 mol/mol (see Table 15, row 16), and the comprehensive gas working design flow rate of this section of pipe fittings is 0.218 Nm³/h. Taking acidic desalinated water, target product gas being ultra-pure hydrogen and a desalinated water flow rate of 100 L/h for producing ultra-pure hydrogen as an example, the minimum vapor-liquid ratio (V/L) is 0.000419 mol/mol (see Table 17, row 16), and the comprehensive gas working design flow rate of this section of pipe fitting is 0.152 Nm³/h.
Parameter 8. The pipe diameter for supplying from the tee to the mixing nozzle (111), the flow rate regulating valve (735), the pressure regulating valve (733) and the flow rate indicator (736), their gas working design flow rates are the minimum vapor-liquid ratio multiplied by the desalinated water flow rate. Taking alkaline desalinated water, target product gas being ultra-pure hydrogen and a desalinated water flow rate of 100 L/h as an example, the minimum vapor-liquid ratio (V/L) is 0.000947 mol/mol (see Table 15, row 16), and the design point of gas flow rate for this section of pipe fitting is 0.118 Nm³/h. Taking acidic desalinated water, target product gas being ultra-pure hydrogen and a desalinated water flow rate of 100 L/h as an example, the minimum vapor-liquid ratio (V/L) is 0.000419 mol/mol (see Table 17, row 16), and the design point of gas flow rate for this section of pipe fitting is 0.052 Nm³/h.
Parameter 9. The pipe diameter for supplying from the tee to the aeration pipe (112), the flow rate regulating valve (745), the pressure regulating valve (743) and the flow rate indicator (746), their gas working design flow rates are the volume flow rate of the desalinated water. Taking a desalinated water flow rate of 100 L/h as an example, the gas working design flow rate of this section of pipe fitting is 0.10 Nm³/h.

A liquid level switch valve (732) is added between the on-off valve (731) and the pressure regulating valve (733) and a pneumatic control signal line is connected to the liquid level indicator and switch (116). During the period when the liquid level of the storage tank (101) is high (the liquid level of the storage tank is set to ≥95% to avoid overflow), the liquid level switch valve (732) is interlocked to close for saving the externally-supplied gas used for atomization and stripping. Likewise, the gas working design flow rate of the liquid level switch valve (732) is the minimum vapor-liquid ratio multiplied by the desalinated water flow rate. Taking alkaline desalinated water, target product gas being ultra-pure hydrogen and a desalinated water flow rate of 100 L/h as an example, the minimum vapor-liquid ratio (V/L) is 0.000947 mol/mol (see Table 15, row 16), and the gas working design flow rate of this liquid level switch valve is 0.118 Nm³/h. Taking acidic desalinated water, target product gas being ultra-pure hydrogen and a desalinated water flow rate of 100 L/h as an example, the minimum vapor-liquid ratio (V/L) is 0.000419 mol/mol (see Table 17, row 16), and the gas working design flow rate of this liquid level switch valve is 0.052 Nm³/h.

A flange connection is added near the top of the desalinated water storage tank (101) for adding a sight glass (113), the position should be convenient for the operator to inspect the nozzle (111) and the spraying conditions. Add a droplet catcher (114) on the exhaust pipe at the top of the storage tank (101) and above the nozzle to capture water in the supersaturated water vapor in the exhaust and recycle to the storage tank (101) to reduce the drift loss of the desalinated water.

Add a check valve (115) on the pipe of the droplet catcher outlet of the desalinated water storage tank (101) to prevent air from infiltration and to provide a stable blanketing pressure to the desalinated water storage tank (101).

Since hydrogen gas is fed into the storage tank (101), a pressure gauge (117) and a pressure safety valve assembly (118) should be added on the top of the tank to facilitate monitoring of the pressure inside the tank and protect the container from overpressure in the event of failure of the pressure regulating valves (733, 743) and the check valve (115).

The exhaust gases from the desalinated water storage tank (101) and from the pressure safety valve assembly (118) should be collected through a pipe and connected to an outdoor high position and safely discharged through a flame arrester (119).

The data table related to the present invention is as follows:

TABLE 4
Technical requirements for pure hydrogen, high pure hydrogen and
ultrapure hydrogen in GB/T 3634.2-2011

| | | Indicators | | |
|---|---|---|---|---|
| Item name | | Pure H₂ | High-purity H₂ | Ultra-pure H₂ |
| Hydrogen (H₂) purity (volume fraction)/10⁻² | ≥ | 99.99 | 99.999 | 99.9999 |
| Oxygen (O₂) content (volume fraction)/10⁻⁶ | ≤ | 5 | 1 | 0.2 |
| Argon (Ar) content (volume fraction)/10⁻⁶ | ≤ | supply-demand | supply-demand | |
| | | determinant | determinant | |
| Nitrogen (N₂) content (volume fraction)/10⁻⁶ | ≤ | 60 | 5 | 0.4 |
| Carbon monoxide (CO) content (volume fraction)/10⁻⁶ | ≤ | 5 | 1 | 0.1 |
| Carbon dioxide (CO₂) content (volume fraction)/10⁻⁶ | ≤ | 5 | 1 | 0.1 |
| Methane (CH₄) content (volume fraction)/10⁻⁶ | ≤ | 10 | 1 | 0.2 |
| Water (H₂O) content (volume fraction)/10⁻⁶ | ≤ | 10 | 3 | 0.5 |
| Total impurity content (volume fraction)/10⁻⁶ | ≤ | — | 10 | 1 |

TABLE 5
Technical requirements for pure oxygen, high purity oxygen and ultra pure
oxygen in GB/T 14599-2008

| | | Indicators | | |
|---|---|---|---|---|
| Item name | | Pure O₂ | High-purity O₂ | Ultra-pure O₂ |
| Oxygen (O₂) purity (volume fraction)/10⁻² | ≥ | 99.995 | 99.999 | 99.9999 |
| Hydrogen (H₂) content (volume fraction)/10⁻⁶ | ≤ | 1 | 0.5 | 0.1 |
| Argon (Ar) content (volume fraction)/10⁻⁶ | ≤ | 10 | 2 | 0.2 |
| Nitrogen (N₂) content (volume fraction)/10⁻⁶ | ≤ | 20 | 5 | 0.1 |
| Carbon dioxide (CO₂) content (volume fraction)/10⁻⁶ | ≤ | 1 | 0.5 | 0.1 |
| Total hydrocarbon content (volume fraction) (for CH₄)/10⁻⁶ | ≤ | 2 | 0.5 | 0.1 |
| Water (H₂O) content (volume fraction)/10⁻⁶ | ≤ | 3 | 2 | 0.5 |

TABLE 6
Table of symbols of the mathematical formulas involved in the present invention

| Symbols | Description | Unit |
|---|---|---|
| _{H}V | Stripping gas (H₂) flow rate | mol/h |
| _{H}y₀ | Impurity concentration in stripping gas (H₂) | mol/mol |
| _{H}y₂ | Impurity concentration in crude H₂ (at gas-liquid seperator outlet) | mol/mol |
| _{H}y₃ | Impurity concentration in initial product H₂ (at electrolysis cell outlet) | mol/mol |
| K_{H}^{px} | Henry's Law constant | atm |
| L | Desalinated water flow rate | mol/h |
| _{O}V | Stripping gas (O₂) flow rate | mol/h |
| y₀ | Impurity concentration in stripping gas | mol/mol |
| _{E}y₀ | Impurity concentration in stripping gas (externally-supplied) | mol/mol |
| _{O}y₀ | Impurity concentration in stripping gas (O₂) | mol/mol |
| _{O}y₂ | Impurity concentration in crude O₂ (at gas-liquid seperator outlet) | mol/mol |
| _{O}y₃ | Impurity concentration in initial product O₂ (at electrolysis cell outlet) | mol/mol |
| P₀ | Partial pressure (at desalinated water storage tank inlet). | Pa |
| P₁ | Absolute pressure (at desalinated water storage tank inlet) | atm |
| V | Stripping gas flow rate | mol/h |
| V/L | Vapor-liquid ratio (the flow rate ratio of stripping gas over desalinated water) | mol/mol |
| x₀ | Impurity concentration in desalinated water (at desalinated water storage tank inlet) | mol/mol |
| x₁ | Impurity concentration in desalinated water (at desalinated water storage tank outlet) | mol/mol |
| x₂ | Impurity concentration in desalinated water (at gas-liquid separator outlet) | mol/mol |
| y | Impurity concentration requirement of target product gas (no more than) | mol/mol |
| y₂ | Impurity concentration in crude product gas (H₂ or O₂) (at gas-liquid seperator outlet) | mol/mol |

TABLE 7
Calculation formulas under the condition where desalinated water being
alkaline and self-produced hydrogen as stripping gas

| | | | |
|---|---|---|---|
| Balance of materials entering and exiting [1] | | L*x₀ + V*_{H}y₀ = L*x₁ + V*_{y1} | Equation 1 |
| Henry's Law at [1] | | K_{H}^{px} = p₁/x₁ = y₁*P₁/x₁ | Equation 2 |
| Combining equations 1 and 2 | | L*x₀ + V*_{H}y₀ = L*x₁+ V*(K_{H}^{px}*x₁/P₁) | |
| | ⇒ | V/L = (x₀ − x₁)/(K_{H}^{px}*x₁/P₁ − _{H}y₀) | Equation 3 |
| Balance of materials entering and exiting [2] | | L*x₁ + _{O}V*_{O}y₃ + _{H}V*_{H}y₃ = L*x₂ + _{O}V*_{O}y₂ + _{H}V*_{H}y₂ | Equation 4 |
| Overall chemical reaction | | 2H₂O → 2H₂ + O₂ | |
| According to the stoichiometry | | _{H}V/L = 1/1 | Equation 5 |
| According to the stoichiometry | | _{O}V/L = 1/2 | Equation 6 |
| Combining equations 4, 5 and 6 | | x₁ + 0.5_{O}y₃ + _{H}y₃ = x₂ + 0.5_{O}y₂ + _{H}y₂ | Equation 7 |
| Balance of materials entering and exiting [3] | | L*x₂ = _{O}V*_{O}y₃ + _{H}V*_{H}y₃ | Equation 8 |
| For alkaline desalinated water | | | |
| Chemical reaction at anode side | | 4OH⁻ → O₂ + 2H₂O + 4e⁻ | |
| No H₂O decomposed, therefore no solute released | | _{O}y₃ = 0 | Equation 9 |
| Combining equations 5, 6, 8 and 9 | | _{H}y₃ = x₂ | Equation 10 |
| Combining equations 7, 9 and 10 | | x₁ = 0.5_{O}y₂ + _{H}y₂ | Equation 11 |
| For crude product gas to meet the specification of | | y₂ ≤ y | Equation 12 |
| target impurity contents | | | |
| Gas-liquid separator [2] of max. mass transfer | | | |
| Henry's Law at [2] | | K_{H}^{px}_{T} = p₂/x₂ = _{O}y₂*P₂/x₂ = _{H}y₂*P₂/x₂ | Equation 13 |
| | ⇒ | _{O}y₂ = _{H}y₂ (=y₂) | Equation 14 |
| Combining equations 11 and 14 | | x₁ = 1.5y₂ | Equation 15 |
| Combining equations 3, 12 and 15 | | V/L ≥ (x₀ − 1.5y)/(K_{H}^{px}*1.5y/P₁ − _{H}y₀) | Equation 16 |
| | ⇒ | y₂ ≤ 2/3*(x₀ + V/L*_{H}y₀)/(V/L*K_{H}^{px}/P₁ + 1) | Equation 17 |
| Gas-liquid separator [2] of zero mass transfer | | _{O}y₂ = _{O}y₃ = 0 | Equation 18 |
| Balance of materials entering and exiting [2 + 3] | | L*x₁ = _{O}V*_{O}y₂ + _{H}V*_{H}y₂ | Equation 19 |
| Combining equations 5 and 19 | | x₁ = _{H}y₂ | Equation 20 |
| Combining equations 3, 12 and 19 | | V/L ≥ (x₀ − y)/(K_{H}^{px}*y/P₁ − _{H}y₀) | Equation 21 |
| | ⇒ | _{H}y₂ ≤ (x₀ + V/L*_{H}y₀)/(V/L*K_{H}^{px}/P₁) + 1) | Equation 22 |

TABLE 8
Calculation formulas under the condition where desalinated water being
alkaline and self-produced oxygen as stripping gas

| | | | |
|---|---|---|---|
| Balance of materials entering and exiting [1] | | L*x₀ + V*_{O}y₀ = L*x₁ + V*_{y1} | Equation 1 |
| Henry's Law at [1] | | K_{H}^{px} = p₁/x₁ = y₁*P₁/x₁ | Equation 2 |
| Combining equations 1 and 2 | | L*x₀ + V*_{O}y₀ = L*x₁+ V*(K_{H}^{px}*x₁/P₁) | |
| | ⇒ | V/L = (x₀ − x₁)/(K_{H}^{px}*x₁/P₁ − _{O}y₀) | Equation 3 |
| Balance of materials entering and exiting [2] | | L*x₁ + _{O}V*_{O}y₃ + _{H}V*_{H}y₃ = L*x₂ + _{O}V*_{O}y₂ + _{H}V*_{H}y₂ | Equation 4 |
| Overall chemical reaction | | 2H₂O → 2H₂ + O₂ | |
| According to the stoichiometry | | _{H}V/L = 1/1 | Equation 5 |
| According to the stoichiometry | | _{O}V/L = 1/2 | Equation 6 |
| Combining equations 4, 5 and 6 | | x₁ + 0.5_{O}y₃ + _{H}y₃ = x₂ + 0.5_{O}y₂ + _{H}y₂ | Equation 7 |
| Balance of materials entering and exiting [3] | | L*x₂ = _{O}V*_{O}y₃ + _{H}V*_{H}y₃ | Equation 8 |
| For alkaline desalinated water | | | |
| Chemical reaction at anode | | 4OH⁻ → O₂ + 2H₂O + 4e⁻ | |
| No H₂O decomposed, therefore no solute released | | _{O}y₃ = 0 | Equation 9 |
| Combining equations 5, 6, 8 and 9 | | _{H}y₃ = x₂ | Equation 10 |
| Combining equations 7, 9 and 10 | | x₁ = 0.5_{O}y₂ + _{H}y₂ | Equation 11 |
| For crude product gas to meet with indicators of | | y₂ ≤ y | Equation 12 |
| target impurity contents | | | |
| Gas-liquid separator [2] of max. mass transfer | | | |
| Henry's Law at [2] | | K_{H}^{px}_{T} = p₂/x₂ = _{O}y₂*P₂/x₂ = _{H}y₂*P₂/x₂ | Equation 13 |
| | ⇒ | _{O}y₂ = _{H}y₂ (=y₂) | Equation 14 |
| Combining equations 11 and 14 | | x₁ = 1.5y₂ | Equation 15 |
| Combining equations 3, 12 and 15 | | V/L ≥ (x₀ − 1.5y)/(K_{H}^{px}*1.5y/P₁ − _{O}y₀) | Equation 16 |
| | ⇒ | y₂ ≤ 2/3*(x₀ + V/L*_{O}y₀)/(V/L*K_{H}^{px}/P₁ + 1) | Equation 17 |
| Gas-liquid separator [2] of zero mass transfer | | _{O}y₂ = _{O}y₃ = 0 | Equation 18 |
| Balance of materials entering and exiting [2 + 3] | | L*x₁ = _{O}V*_{O}y₂ + _{H}V*_{H}y₂ | Equation 19 |
| Combining equations 5 and 19 | | x₁ = _{H}y₂ | Equation 20 |
| Combining equations 3, 12 and 19 | | V/L ≥ (x₀ − y)/(K_{H}^{px}*y/P₁ − _{O}y₀) | Equation 21 |
| | ⇒ | _{H}y₂ ≤ (x₀ + V/L*_{H}y₀)/(V/L*K_{H}^{px}/P₁) + 1) | Equation 22 |

TABLE 9
Calculation formulas under the condition where desalinated water being
acidic/neutral and self-produced hydrogen as stripping gas

| | | | |
|---|---|---|---|
| Balance of materials entering and exiting [1] | | L*x₀ + V*_{H}y₀ = L*x₁ + V*_{y1} | Equation 1 |
| Henry's Law at [1] | | K_{H}^{px} = p₁/x₁ = y₁*P₁/x₁ | Equation 2 |
| Combining equations 1 and 2 | | L*x₀ + V*_{H}y₀ = L*x₁+ V*(K_{H}^{px}*x₁/P₁) | |
| | ⇒ | V/L = (x₀ − x₁)/(K_{H}^{px}*x₁/P₁ − _{H}y₀) | Equation 3 |
| Balance of materials entering and exiting [2] | | L*x₁ + _{O}V*_{O}y₃ + _{H}V*_{H}y₃ = L*x₂ + _{O}V*_{O}y₂ + _{H}V*_{H}y₂ | Equation 4 |
| Overall chemical reaction | | 2H₂O → 2H₂ + O₂ | |
| According to the stoichiometry | | _{H}V/L = 1/1 | Equation 5 |
| According to the stoichiometry | | _{O}V/L = 1/2 | Equation 6 |
| Combining equations 4, 5 and 6 | | x₁ + 0.5_{O}y₃ + _{H}y₃ = x₂ + 0.5_{O}y₂ + _{H}y₂ | Equation 7 |
| Balance of materials entering and exiting [3] | | L*x₂ = _{O}V*_{O}y₃ + _{H}V*_{H}y₃ | Equation 8 |
| For acidic or neutral desalinated water | | | |
| Chemical reaction at cathode | | 2H⁺ + 2e⁻ → H2 | |
| No H₂O decomposed, therefore no solute released | | _{H}y₃ = 0 | Equation 9 |
| Combining equations 5, 6, 8 and 9 | | _{O}y₃ = 2x₂ | Equation 10 |
| Combining equations 7, 9 and 10 | | x₁ = 0.5_{O}y₂ + _{H}y₂ | Equation 11 |
| For crude product gas to meet with indicators of | | y₂ ≤ y | Equation 12 |
| target impurity contents | | | |
| Gas-liquid separator [2] of max. mass transfer | | | |
| Henry's Law at [2] | | K_{H}^{px}_{T} = p₂/x₂ = _{O}y₂*P₂/x₂ = _{H}y₂*P₂/x₂ | Equation 13 |
| | ⇒ | _{O}y₂ = _{H}y₂ (=y₂) | Equation 14 |
| Combining equations 11 and 14 | | x₁ = 1.5y₂ | Equation 15 |
| Combining equations 3, 12 and 15 | | V/L ≥ (x₀ − 1.5y)/(K_{H}^{px}*1.5y/P₁ − _{H}y₀) | Equation 16 |
| | ⇒ | y₂ ≤ 2/3*(x₀ + V/L*_{H}y₀)/(V/L*K_{H}^{px}/P₁ + 1) | Equation 17 |
| Gas-liquid separator [2] of zero mass transfer | | _{H}y₂ = _{H}y₃ = 0 | Equation 18 |
| Balance of materials entering and exiting [2 + 3] | | L*x₁ = _{O}V*_{O}y₂ + _{H}V*_{H}y₂ | Equation 19 |
| Combining equations 5 and 19 | | x₁ = 0.5_{O}y₂ | Equation 20 |
| Combining equations 3, 12 and 19 | | V/L ≥ (x₀ − y)/(K_{H}^{px}*y/P₁ − _{H}y₀) | Equation 21 |
| | ⇒ | _{O}y₂ ≤ (x₀ + V/L*_{H}y₀)/(V/L*K_{H}^{px}/P₁) + 1) | Equation 22 |

TABLE 10
Calculation formulas under the condition where desalinated water being
acidic/neutral and self-produced oxygen as stripping gas

| | | | |
|---|---|---|---|
| Balance of materials entering and exiting [1] | | L*x₀ + V*_{O}y₀ = L*x₁ + V*_{y1} | Equation 1 |
| Henry's Law at [1] | | K_{H}^{px} = p₁/x₁ = y₁*P₁/x₁ | Equation 2 |
| Combining equations 1 and 2 | | L*x₀ + V*_{O}y₀ = L*x₁+ V*(K_{H}^{px}*x₁/P₁) | |
| | ⇒ | V/L = (x₀ − x₁)/(K_{H}^{px}*x₁/P₁ − _{O}y₀) | Equation 3 |
| Balance of materials entering and exiting [2] | | L*x₁ + _{O}V*_{O}y₃ + _{H}V*_{H}y₃ = L*x₂ + _{O}V*_{O}y₂ + _{H}V*_{H}y₂ | Equation 4 |
| Overall chemical reaction | | 2H₂O → 2H₂ + O₂ | |
| According to the stoichiometry | | _{H}V/L = 1/1 | Equation 5 |
| According to the stoichiometry | | _{O}V/L = 1/2 | Equation 6 |
| Combining equations 4, 5 and 6 | | x₁ + 0.5_{O}y₃ + _{H}y₃ = x₂ + 0.5_{O}y₂ + _{H}y₂ | Equation 7 |
| Balance of materials entering and exiting [3] | | L*x₂ = _{O}V*_{O}y₃ + _{H}V*_{H}y₃ | Equation 8 |
| For acidic or neutral desalinated water | | | |
| Chemical reaction at cathode | | 2H⁺ + 2e⁻ → H2 | |
| No H2O decomposed, therefore no solute released | | _{H}y₃ = 0 | Equation 9 |
| Combining equations 5, 6, 8 and 9 | | _{O}y₃ = 2x₂ | Equation 10 |
| Combining equations 7, 9 and 10 | | x₁ = 0.5*_{O}y₂ + _{H}y₂ | Equation 11 |
| For crude product gas to meet with indicators of | | y₂ ≤ y | Equation 12 |
| target impurity contents | | | |
| Gas-liquid separator [2] of max. mass transfer | | | |
| Henry's Law at [2] | | K_{H}^{px}_{T} = p₂/x₂ = _{O}y₂*P₂/x₂ = _{H}y₂*P₂/x₂ | Equation 13 |
| | ⇒ | _{O}y₂ = _{H}y₂ (=y₂) | Equation 14 |
| Combining equations 11 and 14 | | x₁ = 1.5y₂ | Equation 15 |
| Combining equations 3, 12 and 15 | | V/L ≥ (x₀ − 1.5y)/(K_{H}^{px}*1.5y/P₁ − _{O}y₀) | Equation 16 |
| | ⇒ | y₂ ≤ 2/3*(x₀ + V/L*_{O}y₀)/(V/L*K_{H}^{px}/P₁ + 1) | Equation 17 |
| Gas-liquid separator [2] of zero mass transfer | | _{H}y₂ = _{H}y₃ = 0 | Equation 18 |
| Balance of materials entering and exiting [2 + 3] | | L*x₁ = _{O}V*_{O}y₂ + _{H}V*_{H}y₂ | Equation 19 |
| Combining equations 5 and 19 | | x₁ = _{O}y₂ | Equation 20 |
| Combining equations 3, 12 and 19 | | V/L ≥ (x₀ − y)/(K_{H}^{px}*y/P₁ − _{O}y₀) | Equation 21 |
| | ⇒ | _{O}y₂ ≤ (x₀ + V/L*_{O}y₀)/(V/L*K_{H}^{px}/P₁) + 1) | Equation 22 |

TABLE 11
Data table under the condition where desalinated water being
alkaline and self-produced hydrogen as stripping gas

| Row No. | Symbol | Unit | Description | Equation |
|---|---|---|---|---|
| 1 | | % | Volume ratio of air components | |
| 2 | p₀ | atm | Partial pressure of air components | |
| 3 | K_{H}^{px} | atm | Henry's Law constant | K_{H}^{px} = p₀/x |
| 4 | x₀ | mol/mol | Solute component in desalinated water | x₀ = p₀/K_{H}^{px} |
| 5 | _{H}y₂ | mol/mol | Initial gas (before stripping, x1 = x0) - according to separator | |
| 6 | | ppmV | of zero mass transfer | _{H}y₂ = x₀ |
| 7 | | | Target grade of product gas | |
| 8 | y | ppmV | Target component of product gas≤ | |
| 9 | | mol/mol | | |
| 10 | _{H}y₀ | mol/mol | Stripping gas (initial gas) | |
| 11 | V/L | mol/mol | Vapor-liquid ratio - according to separator of zero mass transfer | Table 7 Eqt. 21 |
| 12 | V/L | mol/mol | Vapor-liquid ratio - meeting all target components | |
| 13 | _{H}y₂ | mol/mol | First batch of crude product gas (stripping with intial gas) | Table 7 Eqt. 22 |
| 14 | _{H}y₀ | mol/mol | Stripping gas (first batch of crude product H₂) | |
| 15 | V/L | mol/mol | Vapor-liquid ratio - according to seperator of zero mass transfer | Table 7 Eqt. 21 |
| 16 | V/L | mol/mol | Min. vapor-liquid ratio - meeting all target components | |
| 17 | _{H}y₂ | mol/mol | Component of crude product gas≤ | Table 7 Eqt. 22 |
| 18 | | ppmV | | |
| 19 | | | Target grade of product gas | |
| 20 | y | ppmV | Target impurity of product gas≤ | |
| 21 | | mol/mol | | |
| 22 | _{H}y₀ | mol/mol | Stripping gas (initial gas) | |
| 23 | V/L | mol/mol | Vapor-liquid ratio - according to separator of maximum mass transfer | Table 7 Eqt. 16 |
| 24 | V/L | mol/mol | Vapor-liquid ratio - meeting all target compositions | |
| 25 | _{O}y₂ | mol/mol | First batch of crude product gas (stripping with intial gas) | Table 7 Eqt. 17 |
| 26 | _{H}y₀ | mol/mol | Stripping gas (first batch of crude product H₂, zero mass transfer) | Table 7 Eqt. 22 |
| 27 | V/L | mol/mol | Vapor-liquid ratio - according to separator of max. mass transfer | Table 7 Eqt. 16 |
| 28 | V/L | mol/mol | Min. vapor-liquid ratio - meeting all target compositions | |
| 29 | _{O}y₂ | mol/mol | Component of crude product gas≤ | Table 7 Eqt. 17 |
| 30 | | ppmV | | |

| Row No. | H₂ | O₂ | Ar | N2 | CO | CO₂ | CH₄ |
|---|---|---|---|---|---|---|---|
| 1 | 0.00% | 20.94% | 0.93% | 78.08% | 0.00% | 0.04% | 0.00% |
| 2 | 5.5E−07 | 2.1E−01 | 9.3E−03 | 7.8E−01 | 5.0E−08 | 4.2E−04 | 1.9E−06 |
| 3 | 7.0E+04 | 4.2E+04 | 3.9E+04 | 8.5E+04 | 5.6E+04 | 1.7E+03 | 3.9E+04 |
| 4 | 7.9E−12 | 5.0E−06 | 2.4E−07 | 9.1E−06 | 8.9E−13 | 2.5E−07 | 4.9E−11 |
| 5 | 1.0E+00 | 5.0E−06 | 2.4E−07 | 9.1E−06 | 8.9E−13 | 2.5E−07 | 4.9E−11 |
| 6 | 999985 | 4.98 | 0.24 | 9.15 | 0.00 | 0.25 | 0.0 |
| 7 | Ultra-pure H₂ | | | | | | |
| 8 | 999999 | 0.2 | 0.2 | 0.4 | 0.1 | 0.1 | 0.2 |
| 9 | 1.0E+00 | 2.0E−07 | 2.0E−07 | 4.0E−07 | 1.0E−07 | 1.0E−07 | 2.0E−07 |
| 10 | 1.0E+00 | 5.0E−06 | 2.4E−07 | 9.1E−06 | 8.9E−13 | 2.5E−07 | 4.9E−11 |
| 11 | −1.4E−05 | 5.7E−04 | 5.1E−06 | 2.6E−04 | −1.8E−05 | 9.2E−04 | −2.6E−05 |
| 12 | 9.195E−04 | | | | | | |
| 13 | 1.0E+00 | 1.3E−07 | 6.5E−09 | 1.2E−07 | 1.7E−14 | 1.0E−07 | 1.3E−12 |
| 14 | 1.0E+00 | 1.3E−07 | 6.5E−09 | 1.2E−07 | 1.7E−14 | 1.0E−07 | 1.3E−12 |
| 15 | −1.4E−05 | 5.7E−04 | 5.1E−06 | 2.6E−04 | −1.8E−05 | 9.2E−04 | −2.6E−05 |
| 16 | 0.00092 | | | | | | |
| 17 | 1.0E+00 | 1.3E−07 | 6.5E−09 | 1.2E−07 | 1.7E−14 | 1.0E−07 | 1.3E−12 |
| 18 | 999999.7 | 0.13 | 0.01 | 0.12 | 0.00 | 0.1000 | 0.00 |
| 19 | Ultra-pure O₂ | | | | | | |
| 20 | 0.1 | 999999 | 0.2 | 0.1 | 0.4 | 0.1 | 0.1 |
| 21 | 1.0E−07 | 1.0E+00 | 2.0E−07 | 1.0E−07 | 4.0E−07 | 1.0E−07 | 1.0E−07 |
| 22 | 1.0E+00 | 5.0E−06 | 2.4E−07 | 9.1E−06 | 8.9E−13 | 2.5E−07 | 4.9E−11 |
| 23 | 1.5E−07 | −2.4E−05 | −5.2E−06 | 7.0E−04 | −1.8E−05 | 4.1E−04 | −2.6E−05 |
| 24 | 7.035E−04 | | | | | | |
| 25 | | | | | | | |
| 26 | 1.0E+00 | 1.6E−07 | 8.4E−09 | 1.5E−07 | 2.2E−14 | 1.2E−07 | 1.7E−12 |
| 27 | 1.5E−07 | −2.4E−05 | −5.2E−06 | 7.0E−04 | −1.8E−05 | 4.1E−04 | −2.6E−05 |
| 28 | 0.0007 | | | | | | |
| 29 | 9.3E−06 | 1.0E+00 | 5.6E−09 | 1.0E−07 | 1.5E−14 | 7.8E−08 | 1.1E−12 |
| 30 | 9.33 | 999990.5 | 0.01 | 0.1000 | 0.00 | 0.08 | 0.00 |

TABLE 12
Data table under the condition where desalinated water being
alkaline and self-produced oxygen as stripping gas

| Row No. | Symbol | Unit | Description | Equation |
|---|---|---|---|---|
| 1 | | % | Volume ratio of air components | |
| 2 | p₀ | atm | Partial pressure of air components | |
| 3 | K_{H}^{px} | atm | Henry's Law constant | K_{H}^{px} = p₀/x |
| 4 | x₀ | mol/mol | Solute component in desalinated water | x₀ = p₀/K_{H}^{px} |
| 5 | _{O}y₂ | mol/mol | Initial gas (before stripping, x₁ = x₀) - according to separator | |
| 6 | | ppmV | of maximum mass transfer | _{O}y₂ = 2/3x₀ |
| 7 | | | Target grade of product gas | |
| 8 | y | ppmV | Target component of product gas≤ | |
| 9 | | mol/mol | | |
| 10 | _{O}y₀ | mol/mol | Stripping gas (initial gas) | |
| 11 | V/L | mol/mol | Vapor-liquid ratio - according to separator of zero mass transfer | Table 8 Eqt. 21 |
| 12 | V/L | mol/mol | Vapor-liquid ratio - meeting all target components | |
| 13 | _{H}y₂ | mol/mol | First batch of crude product gas (stripping with intial gas) | Table 8 Eqt. 22 |
| 14 | _{O}y₀ | mol/mol | Stripping gas (first batch of crude product O₂, max. mass transfer) | Table 8 Eqt. 17 |
| 15 | V/L | mol/mol | Vapor-liquid ratio - according to seperator of zero mass transfer | Table 8 Eqt. 21 |
| 16 | V/L | mol/mol | Min. vapor-liquid ratio - meeting all target components | |
| 17 | _{H}y₂ | mol/mol | Component of crude product gas≤ | Table 8 Eqt. 22 |
| 18 | | ppmV | | |
| 19 | | | Target grade of product gas | |
| 20 | y | ppmV | Target impurity of product gas≤ | |
| 21 | | mol/mol | | |
| 22 | _{O}y₀ | mol/mol | Stripping gas (initial gas) | |
| 23 | V/L | mol/mol | Vapor-liquid ratio - according to separator of max. mass transfer | Table 8 Eqt. 16 |
| 24 | V/L | mol/mol | Vapor-liquid ratio - meeting all target compositions | |
| 25 | _{O}y₂ | mol/mol | First batch of crude product gas (stripping with intial gas) | Table 8 Eqt. 17 |
| 26 | _{O}y₀ | mol/mol | Stripping gas (first batch of crude product O₂) | |
| 27 | V/L | mol/mol | Vapor-liquid ratio - according to separator of max. mass transfer | Table 8 Eqt. 16 |
| 28 | V/L | mol/mol | Min. vapor-liquid ratio - meeting all target compositions | |
| 29 | _{O}y₂ | mol/mol | Component of crude product gas≤ | Table 8 Eqt. 17 |
| 30 | | ppmV | | |

| Row No. | H₂ | O₂ | Ar | N2 | CO | CO₂ | CH₄ |
|---|---|---|---|---|---|---|---|
| 1 | 0.00% | 20.94% | 0.93% | 78.08% | 0.00% | 0.04% | 0.00% |
| 2 | 5.5E−07 | 2.1E−01 | 9.3E−03 | 7.8E−01 | 5.0E−08 | 4.2E−04 | 1.9E−06 |
| 3 | 7.0E+04 | 4.2E+04 | 3.9E+04 | 8.5E+04 | 5.6E+04 | 1.7E+03 | 3.9E+04 |
| 4 | 7.9E−12 | 5.0E−06 | 2.4E−07 | 9.1E−06 | 8.9E−13 | 2.5E−07 | 4.9E−11 |
| 5 | 5.2E−12 | 1.0E+00 | 1.6E−07 | 6.1E−06 | 5.9E−13 | 1.7E−07 | 3.2E−11 |
| 6 | 0.0 | 999994 | 0.16 | 6.10 | 0.00 | 0.17 | 0.0 |

| | |
|---|---|
| 7 | Ultra-pure H₂ |

| | | | | | | | |
|---|---|---|---|---|---|---|---|
| 8 | 999999 | 0.2 | 0.2 | 0.4 | 0.1 | 0.1 | 0.2 |
| 9 | 1.0E+00 | 2.0E−07 | 2.0E−07 | 4.0E−07 | 1.0E−07 | 1.0E−07 | 2.0E−07 |
| 10 | 5.2E−12 | 1.0E+00 | 1.6E−07 | 6.1E−06 | 5.9E−13 | 1.7E−07 | 3.2E−11 |
| 11 | −1.4E−05 | −4.8E−06 | 5.1E−06 | 2.6E−04 | −1.8E−05 | 9.2E−04 | −2.6E−05 |

| | |
|---|---|
| 12 | 9.190E−04 |

| | | | | | | | |
|---|---|---|---|---|---|---|---|
| 13 | 1.0E+00 | 2.3E−05 | 6.5E−09 | 1.2E−07 | 1.7E−14 | 1.0E−07 | 1.3E−12 |
| 14 | 8.0E−14 | 1.0E+00 | 4.3E−09 | 7.7E−08 | 1.1E−14 | 6.7E−08 | 8.8E−13 |
| 15 | −1.4E−05 | −4.8E−06 | 5.1E−06 | 2.6E−04 | −1.8E−05 | 9.2E−04 | −2.6E−05 |

| | |
|---|---|
| 16 | 0.0009184 |

| | | | | | | | |
|---|---|---|---|---|---|---|---|
| 17 | 1.0E+00 | 2.3E−05 | 6.5E−09 | 1.2E−07 | 1.7E−14 | 1.0E−07 | 1.3E−12 |
| 18 | 999976.5 | 23.33 | 0.01 | 0.12 | 0.00 | 0.1000 | 0.00 |

| | |
|---|---|
| 19 | Ultra-pure O₂ |

| | | | | | | | |
|---|---|---|---|---|---|---|---|
| 20 | 0.1 | 999999 | 0.2 | 0.1 | 0.4 | 0.1 | 0.1 |
| 21 | 1.0E−07 | 1.0E+00 | 2.0E−07 | 1.0E−07 | 4.0E−07 | 1.0E−07 | 1.0E−07 |
| 22 | 5.2E−12 | 1.0E+00 | 1.6E−07 | 6.1E−06 | 5.9E−13 | 1.7E−07 | 3.2E−11 |
| 23 | −1.4E−05 | −2.4E−05 | −5.2E−06 | 7.0E−04 | −1.8E−05 | 4.1E−04 | −2.6E−05 |

| | |
|---|---|
| 24 | 7.034E−04 |

| | | | | | | | |
|---|---|---|---|---|---|---|---|
| 25 | 1.0E−13 | 1.0E+00 | 5.6E−09 | 1.0E−07 | 1.5E−14 | 7.8E−08 | 1.1E−12 |
| 26 | 1.0E−13 | 1.0E+00 | 5.6E−09 | 1.0E−07 | 1.5E−14 | 7.8E−08 | 1.1E−12 |
| 27 | −1.4E−05 | −2.4E−05 | −5.2E−06 | 7.0E−04 | −1.8E−05 | 4.1E−04 | −2.6E−05 |

| | |
|---|---|
| 28 | 0.000703 |

| | | | | | | | |
|---|---|---|---|---|---|---|---|
| 29 | 1.0E−13 | 1.0E+00 | 5.6E−09 | 1.0E−07 | 1.5E−14 | 7.8E−08 | 1.1E−12 |
| 30 | 0.00 | 999999.8 | 0.01 | 0.1000 | 0.00 | 0.08 | 0.00 |

TABLE 13
Data table under the condition where desalinated water being
acidic/neutral and self-produced hydrogen as stripping gas

| Row No. | Symbol | Unit | Description | Equation |
|---|---|---|---|---|
| 1 | | % | Volume ratio of air components | |
| 2 | p₀ | atm | Partial pressure of air components | |
| 3 | K_{H}^{px} | atm | Henry's Law constant | K_{H}^{px} = p₀/x |
| 4 | x₀ | mol/mol | Solute component in desalinated water | x₀ = p₀/K_{H}^{px} |
| 5 | _{H}y₂ | mol/mol | Initial gas (before stripping, x₁ = x₀) - according to separator | |
| 6 | | ppmV | of maximum mass transfer | _{H}y₂ = 2/3*x₀ |
| 7 | | | Target grade of product gas | |
| 8 | y | ppmV | Target component of product gas≤ | |
| 9 | | mol/mol | | |
| 10 | _{H}y₀ | mol/mol | Stripping gas (initial gas) | |
| 11 | V/L | mol/mol | Vapor-liquid ratio - according to separator of max. mass transfer | Table 9 Eqt. 16 |
| 12 | V/L | mol/mol | Vapor-liquid ratio - meeting all target components | |
| 13 | _{H}y₂ | mol/mol | First batch of crude product gas (stripping with intial gas) | Table 9 Eqt. 17 |
| 14 | _{H}y₀ | mol/mol | Stripping gas (first batch of crude product H₂) | |
| 15 | V/L | mol/mol | Vapor-liquid ratio - according to seperator of max. mass transfer | Table 9 Eqt. 16 |
| 16 | V/L | mol/mol | Min. vapor-liquid ratio - meeting all target components | |
| 17 | _{H}y₂ | mol/mol | Component of crude product gas≤ | Table 9 Eqt. 17 |
| 18 | | ppmV | | |
| 19 | | | Target grade of product gas | |
| 20 | y | ppmV | Target impurity of product gas≤ | |
| 21 | | mol/mol | | |
| 22 | _{H}y₀ | mol/mol | Stripping gas (initial gas) | |
| 23 | V/L | mol/mol | Vapor-liquid ratio - according to separator of zero mass transfer | Table 9 Eqt. 21 |
| 24 | V/L | mol/mol | Vapor-liquid ratio - meeting all target compositions | |
| 25 | _{O}y₂ | mol/mol | First batch of crude product gas (stripping with intial gas) | Table 9 Eqt. 22 |
| 26 | _{H}y₀ | mol/mol | Stripping gas (first batch of crude product H₂, max. mass transfer) | Table 9 Eqt. 17 |
| 27 | V/L | mol/mol | Vapor-liquid ratio - according to separator of zero mass transfer | Table 9 Eqt. 21 |
| 28 | V/L | mol/mol | Min. vapor-liquid ratio - meeting all target compositions | |
| 29 | _{O}y₂ | mol/mol | Component of crude product gas≤ | Table 9 Eqt. 22 |
| 30 | | ppmV | | |

| Row No. | H₂ | O₂ | Ar | N2 | CO | CO₂ | CH₄ |
|---|---|---|---|---|---|---|---|
| 1 | 0.00% | 20.94% | 0.93% | 78.08% | 0.00% | 0.04% | 0.00% |
| 2 | 5.5E−07 | 2.1E−01 | 9.3E−03 | 7.8E−01 | 5.0E−08 | 4.2E−04 | 1.9E−06 |
| 3 | 7.0E+04 | 4.2E+04 | 3.9E+04 | 8.5E+04 | 5.6E+04 | 1.7E+03 | 3.9E+04 |
| 4 | 7.9E−12 | 5.0E−06 | 2.4E−07 | 9.1E−06 | 8.9E−13 | 2.5E−07 | 4.9E−11 |
| 5 | 1.0E+00 | 3.3E−06 | 1.6E−07 | 6.1E−06 | 5.9E−13 | 1.7E−07 | 3.2E−11 |
| 6 | 999990 | 3.32 | 0.16 | 6.10 | 0.00 | 0.17 | 0.00 |
| 7 | Ultra-pure H₂ | | | | | | |
| 8 | 999999 | 0.2 | 0.2 | 0.4 | 0.1 | 0.1 | 0.2 |
| 9 | 1.0E+00 | 2.0E−07 | 2.0E−07 | 4.0E−07 | 1.0E−07 | 1.0E−07 | 2.0E−07 |
| 10 | 1.0E+00 | 3.3E−06 | 1.6E−07 | 6.1E−06 | 5.9E−13 | 1.7E−07 | 3.2E−11 |
| 11 | −1.4E−05 | 3.7E−04 | −5.2E−06 | 1.7E−04 | −1.8E−05 | 4.1E−04 | −2.6E−05 |
| 12 | 4.109E−04 | | | | | | |
| 13 | 1.0E+00 | 1.8E−07 | 9.4E−09 | 1.7E−07 | 2.5E−14 | 1.0E−07 | 1.9E−12 |
| 14 | 1.0E+00 | 1.8E−07 | 9.4E−09 | 1.7E−07 | 2.5E−14 | 1.0E−07 | 1.9E−12 |
| 15 | −1.4E−05 | 3.7E−04 | −5.2E−06 | 1.7E−04 | −1.8E−05 | 4.1E−04 | −2.6E−05 |
| 16 | 0.000411 | | | | | | |
| 17 | 1.0E+00 | 1.8E−07 | 9.4E−09 | 1.7E−07 | 2.5E−14 | 1.0E−07 | 1.9E−12 |
| 18 | 999999.5 | 0.18 | 0.01 | 0.17 | 0.00 | 0.1000 | 0.00 |
| 19 | Ultra-pure O₂ | | | | | | |
| 20 | 0.1 | 999999 | 0.2 | 0.1 | 0.4 | 0.1 | 0.1 |
| 21 | 1.0E−07 | 1.0E+00 | 2.0E−07 | 1.0E−07 | 4.0E−07 | 1.0E−07 | 1.0E−07 |
| 22 | 1.0E+00 | 3.3E−06 | 1.6E−07 | 6.1E−06 | 5.9E−13 | 1.7E−07 | 3.2E−11 |
| 23 | 5.0E−08 | −2.4E−05 | 3.6E−05 | 2.1E−03 | −1.8E−05 | 2.4E−03 | −2.6E−05 |
| 24 | 2.445E−03 | | | | | | |
| 25 | | | | | | | |
| 26 | 1.0E+00 | 3.2E−08 | 1.7E−09 | 2.9E−08 | 4.3E−15 | 3.3E−08 | 3.4E−13 |
| 27 | 5.0E−08 | −2.4E−05 | 3.6E−05 | 2.1E−03 | −1.8E−05 | 2.4E−03 | −2.6E−05 |
| 28 | 0.002441 | | | | | | |
| 29 | 2.8E−05 | 1.0E+00 | 5.0E−09 | 8.7E−08 | 1.3E−14 | 1.0E−07 | 1.0E−12 |
| 30 | 28.40 | 999971.4 | 0.00 | 0.0874 | 0.00 | 0.100 | 0.00 |

TABLE 14
Data table under the condition where desalinated water being acidic/neutral
and externally-supplied oxygen as stripping gas

| Row No. | Symbol | Unit | Description | Equation |
|---|---|---|---|---|
| 1 | | % | Volume ratio of air components | |
| 2 | p₀ | atm | Partial pressure of air components | |
| 3 | K_{H}^{px} | atm | Henry's Law constant | K_{H}^{px} = p₀/x |
| 4 | x₀ | mol/mol | Solute component in desalinated water | x₀ = p₀/K_{H}^{px} |
| 5 | _{O}y₂ | mol/mol | Initial gas (before stripping, x1 = x0) - according to separator | _{O}y₂ = 2*x₀ |
| 6 | | ppmV | of zero mass transfer | |
| 7 | | | Target grade of product gas | |
| 8 | y | ppmV | Target component of product gas≤ | |
| 9 | | mol/mol | | |
| 10 | _{O}y₀ | mol/mol | Stripping gas (initial gas) | |
| 11 | V/L | mol/mol | Vapor-liquid ratio - according to separator of max. mass transfer | Table 10 Eqt. 16 |
| 12 | V/L | mol/mol | Vapor-liquid ratio - meeting all target components | |
| 13 | _{H}y₂ | mol/mol | First batch of crude product gas (stripping with intial gas) | Table 10 Eqt. 17 |
| 14 | _{O}y₀ | mol/mol | Stripping gas (first batch of crude product O₂, zero mass transfer) | Table 10 Eqt. 22 |
| 15 | V/L | mol/mol | Vapor-liquid ratio - according to seperator of maximum mass transfer | Table 10 Eqt. 16 |
| 16 | V/L | mol/mol | Min. vapor-liquid ratio - meeting all target components | |
| 17 | _{H}y₂ | mol/mol | Component of crude product gas≤ | Table 10 Eqt. 17 |
| 18 | | ppmV | | |
| 19 | | | Target grade of product gas | |
| 20 | y | ppmV | Target impurity of product gas≤ | |
| 21 | | mol/mol | | |
| 22 | _{O}y₀ | mol/mol | Stripping gas (initial gas) | |
| 23 | V/L | mol/mol | Vapor-liquid ratio - according to separator of zero mass transfer | Table 10 Eqt. 21 |
| 24 | V/L | mol/mol | Vapor-liquid ratio - meeting all target compositions | |
| 25 | _{O}y₂ | mol/mol | First batch of crude product gas (stripping with intial gas) | Table 10 Eqt. 22 |
| 26 | _{O}y₀ | mol/mol | Stripping gas (first batch of crude product O₂) | |
| 27 | V/L | mol/mol | Vapor-liquid ratio - according to separator of zero mass transfer | Table 10 Eqt. 21 |
| 28 | V/L | mol/mol | Min. vapor-liquid ratio - meeting all target compositions | |
| 29 | _{O}y₂ | mol/mol | Component of crude product gas≤ | Table 10 Eqt. 22 |
| 30 | | ppmV | | |

| Row No. | H₂ | O₂ | Ar | N2 | CO | CO₂ | CH₄ |
|---|---|---|---|---|---|---|---|
| 1 | 0.00% | 20.94% | 0.93% | 78.08% | 0.00% | 0.04% | 0.00% |
| 2 | 5.5E−07 | 2.1E−01 | 9.3E−03 | 7.8E−01 | 5.0E−08 | 4.2E−04 | 1.9E−06 |
| 3 | 7.0E+04 | 4.2E+04 | 3.9E+04 | 8.5E+04 | 5.6E+04 | 1.7E+03 | 3.9E+04 |
| 4 | 7.9E−12 | 5.0E−06 | 2.4E−07 | 9.1E−06 | 8.9E−13 | 2.5E−07 | 4.9E−11 |
| 5 | 1.6E−11 | 1.0E+00 | 4.8E−07 | 1.8E−05 | 1.8E−12 | 5.0E−07 | 9.7E−11 |
| 6 | 0.0 | 999981 | 0.48 | 18.30 | 0.00 | 0.50 | 0.0 |
| 7 | Ultra-pure H₂ | | | | | | |
| 8 | 999999 | 0.2 | 0.2 | 0.4 | 0.1 | 0.1 | 0.2 |
| 9 | 1.0E+00 | 2.0E−07 | 2.0E−07 | 4.0E−07 | 1.0E−07 | 1.0E−07 | 2.0E−07 |
| 10 | 1.6E−11 | 1.0E+00 | 4.8E−07 | 1.8E−05 | 1.8E−12 | 5.0E−07 | 9.7E−11 |
| 11 | −1.4E−05 | −4.7E−06 | −5.2E−06 | 1.7E−04 | −1.8E−05 | 4.1E−04 | −2.6E−05 |
| 12 | 4.115E−04 | | | | | | |
| 13 | 1.0E+00 | 1.5E−05 | 9.4E−09 | 1.7E−07 | 2.5E−14 | 1.0E−07 | 1.9E−12 |
| 14 | 5.3E−13 | 1.0E+00 | 2.8E−08 | 5.1E−07 | 7.4E−14 | 3.0E−07 | 5.7E−12 |
| 15 | −1.4E−05 | −4.7E−06 | −5.2E−06 | 1.7E−04 | −1.8E−05 | 4.1E−04 | −2.6E−05 |
| 16 | 0.0004111 | | | | | | |
| 17 | 1.0E+00 | 1.5E−05 | 9.4E−09 | 1.7E−07 | 2.5E−14 | 1.0E−07 | 1.9E−12 |
| 18 | 999984.5 | 15.18 | 0.01 | 0.17 | 0.00 | 0.100 | 0.00 |
| 19 | Ultra-pure O₂ | | | | | | |
| 20 | 0.1 | 999999 | 0.2 | 0.1 | 0.4 | 0.1 | 0.1 |
| 21 | 1.0E−07 | 1.0E+00 | 2.0E−07 | 1.0E−07 | 4.0E−07 | 1.0E−07 | 1.0E−07 |
| 22 | 1.6E−11 | 1.0E+00 | 4.8E−07 | 1.8E−05 | 1.8E−12 | 5.0E−07 | 9.7E−11 |
| 23 | −1.4E−05 | −2.4E−05 | 3.6E−05 | 2.1E−03 | −1.8E−05 | 2.5E−03 | −2.6E−05 |
| 24 | 2.455E−03 | | | | | | |
| 25 | 9.1E−14 | 1.0E+00 | 5.0E−09 | 8.7E−08 | 1.3E−14 | 1.0E−07 | 1.0E−12 |
| 26 | 9.1E−14 | 1.0E+00 | 5.0E−09 | 8.7E−08 | 1.3E−14 | 1.0E−07 | 1.0E−12 |
| 27 | −1.4E−05 | −2.4E−05 | 3.6E−05 | 2.1E−03 | −1.8E−05 | 2.4E−03 | −2.6E−05 |
| 28 | 0.002443 | | | | | | |
| 29 | 9.1E−14 | 1.0E+00 | 5.0E−09 | 8.7E−08 | 1.3E−14 | 1.0E−07 | 1.0E−12 |
| 30 | 0.00 | 999999.8 | 0.00 | 0.09 | 0.00 | 0.100 | 0.00 |

TABLE 15
Data table under the condition where desalinated water being
alkaline and externally-supplied hydrogen as stripping gas

| Row No. | Symbol | Unit | Description | Equation |
|---|---|---|---|---|
| 1 | | % | Volume ratio of air components | |
| 2 | p₀ | atm | Partial pressure of air components | |
| 3 | K_{H}^{px} | atm | Henry's Law constant | K_{H}^{px} = p₀/x |
| 4 | x₀ | mol/mol | Solute component in desalinated water | x₀ = p₀/K_{H}^{px} |
| 5 | | | | |
| 6 | | | | |
| 7 | | | Target grade of product gas | |
| 8 | y | ppmV | Target component of product gas≤ | |
| 9 | | mol/mol | | |
| 10 | _{H}y₀ | mol/mol | Stripping gas (externally-supplied pure H₂) | |
| 11 | V/L | mol/mol | Vapor-liquid ratio - according to separator of zero mass transfer | Table 7 Eqt. 21 |
| 12 | | | | |
| 13 | | | | |
| 14 | | | | |
| 15 | | | | |
| 16 | V/L | mol/mol | Min. vapor-liquid ratio - meeting all target components | |
| 17 | _{H}y₂ | mol/mol | Component of crude product gas≤ | Table 7 Eqt. 22 |
| 18 | | ppmV | | |
| 19 | | | Target grade of product gas | |
| 20 | y | ppmV | Target impurity of product gas≤ | |
| 21 | | mol/mol | | |
| 22 | _{H}y₀ | mol/mol | Stripping gas (externally-supplied pure H₂) | |
| 23 | V/L | mol/mol | Vapor-liquid ratio - according to separator of max. mass transfer | Table 7 Eqt. 16 |
| 24 | | | | |
| 25 | | | | |
| 26 | | | | |
| 27 | | | | |
| 28 | V/L | mol/mol | Min. vapor-liquid ratio - meeting all target compositions | |
| 29 | _{O}y₂ | mol/mol | Component of crude product gas≤ | Table 7 Eqt. 17 |
| 30 | | ppmV | | |

| Row No. | H₂ | O₂ | Ar | N2 | CO | CO₂ | CH₄ |
|---|---|---|---|---|---|---|---|
| 1 | 0.00% | 20.94% | 0.93% | 78.08% | 0.00% | 0.04% | 0.00% |
| 2 | 5.5E−07 | 2.1E−01 | 9.3E−03 | 7.8E−01 | 5.0E−08 | 4.2E−04 | 1.9E−06 |
| 3 | 7.0E+04 | 4.2E+04 | 3.9E+04 | 8.5E+04 | 5.6E+04 | 1.7E+03 | 3.9E+04 |
| 4 | 7.9E−12 | 5.0E−06 | 2.4E−07 | 9.1E−06 | 8.9E−13 | 2.5E−07 | 4.9E−11 |
| 5 | | | | | | | |
| 6 | | | | | | | |

| | |
|---|---|
| 7 | Ultra-pure H₂ |

| | | | | | | | |
|---|---|---|---|---|---|---|---|
| 8 | 999999 | 0.2 | 0.2 | 0.4 | 0.1 | 0.1 | 0.2 |
| 9 | 1.0E+00 | 2.0E−07 | 2.0E−07 | 4.0E−07 | 1.0E−07 | 1.0E−07 | 2.0E−07 |
| 10 | 1.0E+00 | 5.0E−06 | 1.5E−05 | 6.0E−05 | 5.0E−06 | 5.0E−06 | 1.0E−05 |
| 11 | −1.4E−05 | 5.7E−04 | 5.1E−06 | 2.6E−04 | −1.8E−05 | 9.5E−04 | −2.6E−05 |
| 12 | | | | | | | |
| 13 | | | | | | | |
| 14 | | | | | | | |
| 15 | | | | | | | |

| | |
|---|---|
| 16 | 0.000947 |

| | | | | | | | |
|---|---|---|---|---|---|---|---|
| 17 | 1.0E+00 | 1.2E−07 | 6.7E−09 | 1.1E−07 | 8.7E−11 | 1.0E−07 | 2.5E−10 |
| 18 | 999999.7 | 0.1 | 0.01 | 0.11 | 0.00 | 0.1000 | 0.00 |

| | |
|---|---|
| 19 | Ultra-pure O₂ |

| | | | | | | | |
|---|---|---|---|---|---|---|---|
| 20 | 0.1 | 999999 | 0.2 | 0.1 | 0.4 | 0.1 | 0.1 |
| 21 | 1.0E−07 | 1.0E+00 | 2.0E−07 | 1.0E−07 | 4.0E−07 | 1.0E−07 | 1.0E−07 |
| 22 | 1.0E+00 | 5.0E−06 | 1.5E−05 | 6.0E−05 | 5.0E−06 | 5.0E−06 | 1.0E−05 |
| 23 | 1.5E−07 | −2.4E−05 | −5.2E−06 | 7.1E−04 | −1.8E−05 | 4.2E−04 | −2.6E−05 |
| 24 | | | | | | | |
| 25 | | | | | | | |
| 26 | | | | | | | |
| 27 | | | | | | | |

| | |
|---|---|
| 28 | 0.000706 |

| | | | | | | | |
|---|---|---|---|---|---|---|---|
| 29 | 9.3E−06 | 1.0E+00 | 5.8E−09 | 1.0E−07 | 5.8E−11 | 7.9E−08 | 1.7E−10 |
| 30 | 9.33 | 999990.5 | 0.01 | 0.1000 | 0.00 | 0.08 | 0.00 |

TABLE 16
Data table under the condition where desalinated water being
alkaline and externally-supplied oxygen as stripping gas

| Row No. | Symbol | Unit | Description | Equation |
|---|---|---|---|---|
| 1 | | % | Volume ratio of air components | |
| 2 | p₀ | atm | Partial pressure of air components | |
| 3 | K_{H}^{px} | atm | Henry's Law constant | K_{H}^{px} = p₀/x |
| 4 | x₀ | mol/mol | Solute component in desalinated water | x₀ = p₀/K_{H}^{px} |
| 5 | | | | |
| 6 | | | | |
| 7 | | | Target grade of product gas | |
| 8 | y | ppmV | Target component of product gas≤ | |
| 9 | | mol/mol | | |
| 10 | _{O}y₀ | mol/mol | Stripping gas (externally-supplied pure O₂) | |
| 11 | V/L | mol/mol | Vapor-liquid ratio - according to separator of zero mass transfer | Table 8 Eqt. 21 |
| 12 | | | | |
| 13 | | | | |
| 14 | | | | |
| 15 | | | | |
| 16 | V/L | mol/mol | Min. vapor-liquid ratio - meeting all target components | |
| 17 | _{H}y₂ | mol/mol | Component of crude product gas≤ | Table 8 Eqt. 22 |
| 18 | | ppmV | | |
| 19 | | | Target grade of product gas | |
| 20 | y | ppmV | Target impurity of product gas≤ | |
| 21 | | mol/mol | | |
| 22 | _{O}y₀ | mol/mol | Stripping gas (externally-supplied pure O₂) | |
| 23 | V/L | mol/mol | Vapor-liquid ratio - according to separator of max. mass transfer | Table 8 Eqt. 16 |
| 24 | | | | |
| 25 | | | | |
| 26 | | | | |
| 27 | | | | |
| 28 | V/L | mol/mol | Min. vapor-liquid ratio - for meeting all target compositions | |
| 29 | _{O}y₂ | mol/mol | Component of crude product gas≤ | Table 8 Eqt. 17 |
| 30 | | ppmV | | |

| Row No. | H₂ | O₂ | Ar | N2 | CO | CO₂ | CH₄ |
|---|---|---|---|---|---|---|---|
| 1 | 0.00% | 20.94% | 0.93% | 78.08% | 0.00% | 0.04% | 0.00% |
| 2 | 5.5E−07 | 2.1E−01 | 9.3E−03 | 7.8E−01 | 5.0E−08 | 4.2E−04 | 1.9E−06 |
| 3 | 7.0E+04 | 4.2E+04 | 3.9E+04 | 8.5E+04 | 5.6E+04 | 1.7E+03 | 3.9E+04 |
| 4 | 7.9E−12 | 5.0E−06 | 2.4E−07 | 9.1E−06 | 8.9E−13 | 2.5E−07 | 4.9E−11 |
| 5 | | | | | | | |
| 6 | | | | | | | |

| | |
|---|---|
| 7 | Ultra-pure H₂ |

| | | | | | | | |
|---|---|---|---|---|---|---|---|
| 8 | 999999 | 0.2 | 0.2 | 0.4 | 0.1 | 0.1 | 0.2 |
| 9 | 1.0E+00 | 2.0E−07 | 2.0E−07 | 4.0E−07 | 1.0E−07 | 1.0E−07 | 2.0E−07 |
| 10 | 1.0E−06 | 1.0E+00 | 1.0E−05 | 2.0E−05 | 1.6E−05 | 1.0E−06 | 2.0E−06 |
| 11 | −1.4E−05 | −4.8E−06 | 5.1E−06 | 2.6E−04 | −1.8E−05 | 9.2E−04 | −2.6E−05 |
| 12 | | | | | | | |
| 13 | | | | | | | |
| 14 | | | | | | | |
| 15 | | | | | | | |

| | |
|---|---|
| 16 | 0.000924 |

| | | | | | | | |
|---|---|---|---|---|---|---|---|
| 17 | 1.0E+00 | 2.3E−05 | 6.7E−09 | 1.1E−07 | 2.8E−10 | 1.0E−07 | 5.1E−11 |
| 18 | 999976.5 | 23.33 | 0.01 | 0.11 | 0.00 | 0.1000 | 0.00 |

| | |
|---|---|
| 19 | Ultra-pure O₂ |

| | | | | | | | |
|---|---|---|---|---|---|---|---|
| 20 | 0.1 | 999999 | 0.2 | 0.1 | 0.4 | 0.1 | 0.1 |
| 21 | 1.0E−07 | 1.0E+00 | 2.0E−0 | 1.0E−07 | 4.0E−07 | 1.0E−07 | 1.0E−07 |
| 22 | 1.0E−06 | 1.0E+00 | 1.0E−05 | 2.0E−05 | 1.6E−05 | 1.0E−06 | 2.0E−06 |
| 23 | −1.4E−05 | −2.4E−05 | −5.2E−06 | 7.0E−04 | −1.8E−05 | 4.1E−04 | −2.6E−05 |
| 24 | | | | | | | |
| 25 | | | | | | | |
| 26 | | | | | | | |
| 27 | | | | | | | |

| | |
|---|---|
| 28 | 0.000704 |

| | | | | | | | |
|---|---|---|---|---|---|---|---|
| 29 | 9.4E−12 | 1.0E+00 | 5.8E−09 | 1.0E−07 | 1.8E−10 | 7.8E−08 | 3.4E−11 |
| 30 | 0.00 | 999999.8 | 0.01 | 0.100 | 0.00 | 0.08 | 0.00 |

TABLE 17
Data table under the condition where desalinated water being acidic/neutral
and externally-supplied hydrogen as stripping gas

| Row No. | Symbol | Unit | Description | Equation |
|---|---|---|---|---|
| 1 | | % | Volume ratio of air components | |
| 2 | p₀ | atm | Partial pressure of air components | |
| 3 | K_{H}^{px} | atm | Henry's Law constant | K_{H}^{px} = p₀/x |
| 4 | x₀ | mol/mol | Solute component in desalinated water | x₀ = p₀/K_{H}^{px} |
| 5 | | | | |
| 6 | | | | |
| 7 | | | Target grade of product gas | |
| 8 | y | ppmV | Target component of product gas≤ | |
| 9 | | mol/mol | | |
| 10 | _{H}y₀ | mol/mol | Stripping gas (externally-supplied pure H₂) | |
| 11 | V/L | mol/mol | Vapor-liquid ratio - according to separator of max. mass transfer | Table 9 Eqt. 16 |
| 12 | | | | |
| 13 | | | | |
| 14 | | | | |
| 15 | | | | |
| 16 | V/L | mol/mol | Min. vapor-liquid ratio - meeting all target components | |
| 17 | _{H}y₂ | mol/mol | Component of crude product gas≤ | Table 9 Eqt. 17 |
| 18 | | ppmV | | |
| 19 | | | Target grade of product gas | |
| 20 | y | ppmV | Target impurity of product gas≤ | |
| 21 | | mol/mol | | |
| 22 | _{H}y₀ | mol/mol | Stripping gas (externally-supplied pure H₂) | |
| 23 | V/L | mol/mol | Vapor-liquid ratio - according to separator of zero mass transfer | Table 9 Eqt. 21 |
| 24 | | | | |
| 25 | | | | |
| 26 | | | | |
| 27 | | | | |
| 28 | V/L | mol/mol | Min. vapor-liquid ratio - meeting all target compositions | |
| 29 | _{O}y₂ | mol/mol | Component of crude product gas≤ | Table 9 Eqt. 22 |
| 30 | | ppmV | | |

| Row No. | H₂ | O₂ | Ar | N2 | CO | CO₂ | CH₄ |
|---|---|---|---|---|---|---|---|
| 1 | 0.00% | 20.94% | 0.93% | 78.08% | 0.00% | 0.04% | 0.00% |
| 2 | 5.5E−07 | 2.1E−01 | 9.3E−03 | 7.8E−01 | 5.0E−08 | 4.2E−04 | 1.9E−06 |
| 3 | 7.0E+04 | 4.2E+04 | 3.9E+04 | 8.5E+04 | 5.6E+04 | 1.7E+03 | 3.9E+04 |
| 4 | 7.9E−12 | 5.0E−06 | 2.4E−07 | 9.1E−06 | 8.9E−13 | 2.5E−07 | 4.9E−11 |
| 5 | | | | | | | |
| 6 | | | | | | | |

| | |
|---|---|
| 7 | Ultra-pure H₂ |

| | | | | | | | |
|---|---|---|---|---|---|---|---|
| 8 | 999999 | 0.2 | 0.2 | 0.4 | 0.1 | 0.1 | 0.2 |
| 9 | 1.0E+00 | 2.0E−07 | 2.0E−07 | 4.0E−07 | 1.0E−07 | 1.0E−07 | 2.0E−07 |
| 10 | 1.0E+00 | 5.0E−06 | 1.5E−05 | 6.0E−05 | 5.0E−06 | 5.0E−06 | 1.0E−05 |
| 11 | −1.4E−05 | 3.7E−04 | −5.2E−06 | 1.7E−04 | −1.8E−05 | 4.2E−04 | −2.6E−05 |
| 12 | | | | | | | |
| 13 | | | | | | | |
| 14 | | | | | | | |
| 15 | | | | | | | |

| | |
|---|---|
| 16 | 0.000419 |

| | | | | | | | |
|---|---|---|---|---|---|---|---|
| 17 | 1.0E+00 | 1.8E−07 | 9.4E−09 | 1.7E−07 | 5.7E−11 | 1.0E−07 | 1.6E−10 |
| 18 | 999999.5 | 0.18 | 0.01 | 0.17 | 0.00 | 0.100 | 0.00 |

| | |
|---|---|
| 19 | Ultra-pure O₂ |

| | | | | | | | |
|---|---|---|---|---|---|---|---|
| 20 | 0.1 | 999999 | 0.2 | 0.1 | 0.4 | 0.1 | 0.1 |
| 21 | 1.0E−07 | 1.0E+00 | 2.0E−07 | 1.0E−07 | 4.0E−07 | 1.0E−07 | 1.0E−07 |
| 22 | 1.0E+00 | 5.0E−06 | 1.5E−05 | 6.0E−05 | 5.0E−06 | 5.0E−06 | 1.0E−05 |
| 23 | 5.0E−08 | −2.4E−05 | 3.6E−05 | 2.2E−03 | −1.8E−05 | 2.6E−03 | −2.6E−05 |
| 24 | | | | | | | |
| 25 | | | | | | | |
| 26 | | | | | | | |
| 27 | | | | | | | |

| | |
|---|---|
| 28 | 0.002597 |

| | | | | | | | |
|---|---|---|---|---|---|---|---|
| 29 | 2.8E−05 | 1.0E+00 | 5.4E−09 | 8.4E−08 | 1.8E−10 | 1.0E−07 | 5.1E−10 |
| 30 | 28.40 | 999971.4 | 0.01 | 0.0836 | 0.00 | 0.100 | 0.00 |

TABLE 18
Data table under the condition where desalinated water being acidic/neutral
and externally-supplied oxygen as stripping gas

| Row No. | Symbol | Unit | Description | Equation |
|---|---|---|---|---|
| 1 | | % | Volume ratio of air components | |
| 2 | p₀ | atm | Partial pressure of air components | |
| 3 | K_{H}^{px} | atm | Henry's Law constant | K_{H}^{px} = p₀/x |
| 4 | x₀ | mol/mol | Solute component in desalinated water | x₀ = p₀/K_{H}^{px} |
| 5 | | | | |
| 6 | | | | |
| 7 | | | Target grade of product gas | |
| 8 | y | ppmV | Target component of product gas≤ | |
| 9 | | mol/mol | | |
| 10 | _{O}y₀ | mol/mol | Stripping gas (externally-supplied pure O₂) | |
| 11 | V/L | mol/mol | Vapor-liquid ratio - according to separator of max. mass transfer | Table 10 Eqt. 16 |
| 12 | | | | |
| 13 | | | | |
| 14 | | | | |
| 15 | | | | |
| 16 | V/L | mol/mol | Min. vapor-liquid ratio - meeting all target components | |
| 17 | _{H}y₂ | mol/mol | Component of crude product gas≤ | Table 10 Eqt. 17 |
| 18 | | ppmV | | |
| 19 | | | Target grade of product gas | |
| 20 | y | ppmV | Target impurity of product gas≤ | |
| 21 | _{O}y₀ | mol/mol | Stripping gas (externally-supplied pure O₂) | |
| 22 | | mol/mol | | |
| 23 | V/L | mol/mol | Vapor-liquid ratio - according to separator of zero mass transfer | Table 10 Eqt. 21 |
| 24 | | | | |
| 25 | | | | |
| 26 | | | | |
| 27 | | | | |
| 28 | V/L | mol/mol | Min. vapor-liquid ratio - meeting all target compositions | |
| 29 | _{O}y₂ | mol/mol | Component of crude product gas≤ | Table 10 Eqt. 22 |
| 30 | | ppmV | | |

| Row No. | H₂ | O₂ | Ar | N2 | CO | CO₂ | CH₄ |
|---|---|---|---|---|---|---|---|
| 1 | 0.00% | 20.94% | 0.93% | 78.08% | 0.00% | 0.04% | 0.00% |
| 2 | 5.5E−07 | 2.1E−01 | 9.3E−03 | 7.8E−01 | 5.0E−08 | 4.2E−04 | 1.9E−06 |
| 3 | 7.0E+04 | 4.2E+04 | 3.9E+04 | 8.5E+04 | 5.6E+04 | 1.7E+03 | 3.9E+04 |
| 4 | 7.9E−12 | 5.0E−06 | 2.4E−07 | 9.1E−06 | 8.9E−13 | 2.5E−07 | 4.9E−11 |
| 5 | | | | | | | |
| 6 | | | | | | | |
| 7 | Ultra-pure H₂ | | | | | | |
| 8 | 999999 | 0.2 | 0.2 | 0.4 | 0.1 | 0.1 | 0.2 |
| 9 | 1.0E+00 | 2.0E−07 | 2.0E−07 | 4.0E−07 | 1.0E−07 | 1.0E−07 | 2.0E−07 |
| 10 | 1.0E−06 | 1.0E+00 | 1.0E−05 | 2.0E−05 | 1.6E−05 | 1.0E−06 | 2.0E−06 |
| 11 | −1.4E−05 | −4.7E−06 | −5.2E−06 | 1.7E−04 | −1.8E−05 | 4.1E−04 | −2.6E−05 |
| 12 | | | | | | | |
| 13 | | | | | | | |
| 14 | | | | | | | |
| 15 | | | | | | | |
| 16 | 0.000412 | | | | | | |
| 17 | 1.0E+00 | 1.5E−05 | 9.5E−09 | 1.7E−07 | 1.8E−10 | 1.0E−07 | 3.4E−11 |
| 18 | 999984.5 | 15.18 | 0.01 | 0.17 | 0.00 | 0.100 | 0.00 |
| 19 | Ultra-pure O₂ | | | | | | |
| 20 | 0.1 | 999999 | 0.2 | 0.1 | 0.4 | 0.1 | 0.1 |
| 21 | 1.0E−07 | 1.0E+00 | 2.0E−07 | 1.0E−07 | 4.0E−07 | 1.0E−07 | 1.0E−07 |
| 22 | 1.0E−06 | 1.0E+00 | 1.0E−05 | 2.0E−05 | 1.6E−05 | 1.0E−06 | 2.0E−06 |
| 23 | −1.4E−05 | −2.4E−05 | 3.6E−05 | 2.1E−03 | −1.8E−05 | 2.5E−03 | −2.6E−05 |
| 24 | | | | | | | |
| 25 | | | | | | | |
| 26 | | | | | | | |
| 27 | | | | | | | |
| 28 | 0.002470 | | | | | | |
| 29 | 2.8E−11 | 1.0E+00 | 5.4E−09 | 8.7E−08 | 5.6E−10 | 1.0E−07 | 1.0E−10 |
| 30 | 0.00 | 999999.8 | 0.01 | 0.09 | 0.00 | 0.100 | 0.00 |

### LIST OF REFERENCE NUMERALS

The name of the apparatus and description of connection point marked in figures are listed below:

| | | Name of the apparatus and |
|---|---|---|
| Row | Tag No. | description of connection point |
| 1 | 001 | Desalination (pure water) apparatus |
| 2 | 011, 732 | Liquid level switch valve |
| 3 | 012, 735, 745 | Flow rate regulating valve |
| 4 | 013, 736, 746 | Flow rate indicator |
| 5 | 014, 702, 712, 913, 731, 737, 741, 747 | On-off valve |
| 6 | 101 | Storage tank (desalinated water) |
| 7 | 111 | Mixing nozzle |
| 8 | 112 | Aeration pipe |
| 9 | 113 | Sight glass |
| 10 | 114 | Droplet catcher |
| 11 | 115 | Check valve |
| 12 | 116 | Liquid level display switch |
| 13 | 117, 734, 744 | Pressure gauge |
| 14 | 118 | Pressure safety valve assembly |
| 15 | 119 | Flame arrestor |
| 16 | 201 | Electrolytic cell |
| 17 | 311 | Gas-liquid separator (O₂ side) |
| 18 | 411 | Cooling/droplet-catching/gas-liquid |
| | | separating apparatus (O₂ side) |
| 19 | 301 | Gas-liquid separator (H₂ side) |
| 20 | 401 | Cooling/droplet-catching/gas-liquid |
| | | separating apparatus (H₂ side) |
| 21 | 501 | Catalytic |
| | | deoxygenation/condensation/gas-liquid |
| | | separating device |
| 22 | 511 | Catalytic |
| | | dehydrogenation/condensation/gas- |
| | | liquid separating device |
| 23 | 601, 611 | Molecular seive drying adsorption |
| | | device |
| 24 | 701 | Buffer tank (product H₂) |
| 25 | 711 | Buffer tank (product O₂) |
| 26 | 721 | Four-way valve |
| 27 | 733, 743 | Pressure regulating valve |
| 28 | 912 | Filling connector |
| 29 | [symbol] | City water supply point |
| 30 | [symbol] [symbol] [symbol] [symbol] | Connection point between overall |
| | | integration and detailed flow diagrams |
| 31 | [symbol] | Connect to outdoor high-level exhaust |
| 32 | [symbol] | Ultra-pure H₂ to customer |
| 33 | [symbol] | Supply point for external gas |
| 34 | [symbol] | Ultra-pure O₂ to customer |

What is claimed is:

1. A pretreatment method for preparing ultra-pure hydrogen and ultra-pure oxygen, characterized in that, comprising the following steps:
a. before desalinated water entering an electrolytic cell, desalinated water being fed into the top of a storage tank through a desalinated water pipe; at the same time, using hydrogen gas or oxygen gas as a stripping gas, being fed into the top of a storage tank through a gas supply pipe for performing atomization and stripping pretreatment of desalinated water;
b. before desalinated water entering an electrolytic cell, hydrogen gas or oxygen gas being fed into the bottom of a storage tank through a gas supply pipe, using hydrogen gas or oxygen gas to perform bubbling, redundant stripping, and to provide a slightly-positive pressure blanketing on pre-treated desalinated water;
c. performing water-mist separation on the exhaust of a storage tank, of which the water in supersaturated water vapor being captured and recycled to a storage tank;
d. desalinated water obtained after pretreatment being used to produce product hydrogen and product oxygen through the subsequent water electrolysis process flow, and being stored in buffer tank.

2. The pretreatment method for preparing ultra-pure hydrogen and ultra-pure oxygen according to claim 1, characterized in that: in step a, arranging a mixing nozzle on the top of said storage tank, its internal structure having individual independent passages respectively connecting to said gas supply pipe and said desalinated water pipe, two fluids of the fed hydrogen gas or oxygen gas and desalinated water being mixed and collided only at the outlet of said mixing nozzle.

3. The pretreatment method for preparing ultra-pure hydrogen and ultra-pure oxygen according to claim 2, characterized in that: droplet diameter of said desalinated water in step a after atomization through said mixing nozzle being not less than 100 μm.

4. The pretreatment method for preparing ultra-pure hydrogen and ultra-pure oxygen according to claim 1, characterized in that, in step b, arranging an aeration pipe at the bottom of said storage tank, volume flow rate of bubbling hydrogen gas or oxygen gas not less than volume flow rate of desalinated water.

5. The pretreatment method for preparing ultra-pure hydrogen and ultra-pure oxygen according to claim 1, characterized in that: arranging an on-off valve, a pressure regulating valve, a pressure gauge, a flow regulating valve and a flow rate indicator in sequence on said gas supply pipe.

6. The pretreatment method for preparing ultra-pure hydrogen and ultra-pure oxygen according to claim 5, characterized in that: in step a, installing a liquid level on-off valve on said gas supply pipe, between said on-off valve and said pressure regulating valve, on-off setting as close when the liquid level of a storage tank ≥95%.

7. The pretreatment method for preparing ultra-pure hydrogen and ultra-pure oxygen according to claim 2, characterized in that: arranging an exhaust pipe on the top of said storage tank, arranging a droplet catcher on said exhaust pipe.

8. The pretreatment method for preparing ultra-pure hydrogen and ultra-pure oxygen according to claim 7, characterized in that: also including a step of maintaining one slightly-positive pressure blanketing in a storage tank, arranging a check valve on the pipe of said droplet catcher outlet, opening pressure of said check valve not less than 250 N/m².

9. The pretreatment method for preparing ultra-pure hydrogen and ultra-pure oxygen according to claim 1, characterized in that, also including the following steps:
e. feeding said product hydrogen or product oxygen in step d through said gas supply pipe for performing atomization and stripping pretreatment in step a, and/or for performing bubbling, redundant stripping and providing slightly-positive pressure blanketing in step b.

10. The pretreatment method for preparing ultra-pure hydrogen and ultra-pure oxygen according to claim 1, characterized in that, further providing a four-way valve between said gas supply pipe and a buffer tank for selecting product gas or externally-supplied gas as stripping gas.

11. The pretreatment method for preparing ultra-pure hydrogen and ultra-pure oxygen according to claim 1, characterized in that: said desalinated water being alkaline desalinated water, when producing said product hydrogen, in order to meet the target impurity concentration requirement of said product hydrogen, the vapor-liquid ratio of said stripping gas to desalinated water greater than or equal to the following value:
V/L=(x₀−y)/(K_{H}^{px}×y/P₁−y₀)
wherein, V is stripping gas flow rate, L is desalinated water flow rate, x₀ is impurity concentration in desalinated water, y is target impurity concentration requirement in product gas, K_{H}^{px} is Henry's Law constant, P₁ is absolute pressure, y₀ is impurity concentration in stripping gas.

12. The pretreatment method for preparing ultra-pure hydrogen and ultra-pure oxygen according to claim 1, characterized in that: said desalinated water being alkaline desalinated water, when producing said product oxygen, in order to meet the target impurity concentration requirement of said product oxygen, the vapor-liquid ratio of said stripping gas to desalinated water greater than or equal to the following value:
V/L=(x₀−1.5y)/(K_{H}^{px}×1.5y/P₁−y₀)
wherein, V is stripping gas flow rate, L is desalinated water flow rate, x₀ is impurity concentration in desalinated water, y is target impurity concentration requirement in product gas, K_{H}^{px} is Henry's Law constant, P₁ is absolute pressure, y₀ is impurity concentration in stripping gas.

13. The pretreatment method for preparing ultra-pure hydrogen and ultra-pure oxygen according to claim 1, characterized in that: said desalinated water being acidic or neutral desalinated water, when producing said product hydrogen, in order to meet the target impurity concentration requirement of said product hydrogen, the vapor-liquid ratio of said stripping gas to desalinated water greater than or equal to the following value:
V/L=(x₀−1.5y)/(K_{H}^{px}×1.5y/P₁−y₀)
wherein, V is stripping gas flow rate, L is desalinated water flow rate, x₀ is impurity concentration in desalinated water, y is target impurity concentration requirement in product gas, K_{H}^{px} is Henry's Law constant, P₁ is absolute pressure, y₀ is impurity concentration in stripping gas.

14. The pretreatment method for preparing ultra-pure hydrogen and ultra-pure oxygen according to claim 1, characterized in that: said desalinated water being acidic or neutral desalinated water, when producing said product oxygen, in order to meet the target impurity concentration requirement of said product oxygen, the vapor-liquid ratio of said stripping gas to desalinated water greater than or equal to the following value:
V/L=(x₀−0.5y)/(K_{H}^{px}×0.5y/P₁−y₀)
wherein, V is stripping gas flow rate, L is desalinated water flow rate, x₀ is impurity concentration in desalinated water, y is target impurity concentration requirement in product gas, K_{H}^{px} is Henry's Law constant, P₁ is absolute pressure, y₀ is impurity concentration in stripping gas.

15. The pretreatment method for preparing ultra-pure hydrogen and ultra-pure oxygen according to claim 11, characterized in that: when producing said product hydrogen and/or product oxygen, in order to meet all target impurity concentration requirements thereof, vapor-liquid ratio of said stripping gas to desalinated water greater than or equal to the maximum value among the vapor-liquid ratios of all target impurities in said product gas.

16. The pretreatment method for preparing ultra-pure hydrogen and ultra-pure oxygen according to claim 12, characterized in that: when producing said product hydrogen and/or product oxygen, in order to meet all target impurity concentration requirements thereof, vapor-liquid ratio of said stripping gas to desalinated water greater than or equal to the maximum value among the vapor-liquid ratios of all target impurities in said product gas.

17. The pretreatment method for preparing ultra-pure hydrogen and ultra-pure oxygen according to claim 13, characterized in that: when producing said product hydrogen and/or product oxygen, in order to meet all target impurity concentration requirements thereof, vapor-liquid ratio of said stripping gas to desalinated water greater than or equal to the maximum value among the vapor-liquid ratios of all target impurities in said product gas.

18. The pretreatment method for preparing ultra-pure hydrogen and ultra-pure oxygen according to claim 14, characterized in that: when producing said product hydrogen and/or product oxygen, in order to meet all target impurity concentration requirements thereof, vapor-liquid ratio of said stripping gas to desalinated water greater than or equal to the maximum value among the vapor-liquid ratios of all target impurities in said product gas.
